(19) United States
(12) Patent Application Publication
(10) Pub. No.: US 2026/0029814 A1
(43) Pub. Date: Jan. 29, 2026

(54) PHOTONIC NEURAL NETWORK ON THIN-FILM LITHIUM NIOBATE

(71) Applicant: President and Fellows of Harvard College, Cambridge, MA (US)

(72) Inventors: Yaowen Hu, Cambridge, MA (US); Marko Loncar, Cambridge, MA (US); Benjamin Vakoc, Boston, MA (US); Norman Lippok, Boston, MA (US)

(21) Appl. No.: 19/347,439

(22) Filed: Oct. 1, 2025

Related U.S. Application Data
(63) Continuation of application No. PCT/US2024/022835, filed on Apr. 3, 2024.
(60) Provisional application No. 63/493,877, filed on Apr. 3, 2023.
(60) Provisional application No. 63/500,449, filed on May 5, 2023.

(51) Int. Cl. G06E 1/04

(52) U.S. Cl. CPC G06E 1/045

(57) ABSTRACT

According to various embodiments of the present disclosure, systems for and methods of performing a matrix-vector-multiplication operation and/or convolution operation, such as, for artificial neural network processing are provided. The systems described herein may include one or more components that each comprise an electro-optic crystal. The methods described herein may make use of such electro-optic components. In various embodiments, the electro-optic crystal may be lithium niobate.

### CROSS-REFERENCE TO RELATED APPLICATIONS

This application is a continuation under 35 U.S.C. Sect. 111 (a) of International Application No. PCT/US2024/22835, which designated the United States and was filed on Apr. 3, 2024, published in English, which claims the benefit of U.S. Provisional Application No. 63/493,877, filed on Apr. 3, 2023, and U.S. Provisional Application No. 63/500,449, filed on May 5, 2023. The entire teachings of the above applications are incorporated herein by reference.

### BACKGROUND

Artificial neural networks (ANNs) are used for many applications, such as computer vision, including face recognition and automatic driving, as well as natural language processing, stock market prediction, medical diagnosis, etc. An ANN may be implemented using one or more linear transformation, such as matrix-vector-multiplication (MVM), together with one or more nonlinear activation. A few challenges in using ANNs when they are implemented using conventional electronic computer processors may include a low bandwidth for operations and a large power consumption. This may be because an ANN often uses large-scale parallel processing, which may not be suitable for the Von Neumann structure of electronic computer processors from a power consumption perspective. Further, conventional MVM processors may include silicon modulators that may be “power hungry” and have a high power consumption and/or have a low bandwidth. These conventional processors may also lack the ability of efficient and high-speed electro-optic conversion. These conventional processors may also have a high power consumption for encoding weights, for example, due to their use of a heater, which may have a high static power consumption. In addition, conventional processors may use pulse code modulation (PCM), which may require a high-peak-power pulse to adjust the neural network weights and have limited durability. Thus, conventional systems and techniques, such as those using solely electronic computers and systems to implement ANNs, may be energy inefficient, may have a high latency, and may be bandwidth limited. Accordingly, there is a need for systems and methods that can perform ANN operations, such as matrix-vector-multiplication and/or convolution operations, in an energy efficient, low latency, and a high bandwidth manner.

### BRIEF SUMMARY

Embodiments of the present disclosure relate to performing a matrix-vector-multiplication operation and/or a convolution operation in an energy efficient, low latency, and a high bandwidth manner. Such operations may be used for artificial neural network (ANN) processing.

According to various embodiments of the present disclosure, systems for, methods of, and computer program products for performing a matrix-vector-multiplication operation and/or a convolution operation, such as, for artificial neural network processing are provided.

In various embodiments, a system is provided for performing a matrix-vector-multiplication operation in an artificial neural network is provided. The system includes a first electro-optic modulator configured to receive a first electronic signal encoding a data vector, encode the first electronic signal into a first light signal, and spatially fan-out, into different spatial modes, the first light signal into a plurality of light channels. The system includes a plurality of second electro-optic modulators configured to receive a second electronic signal encoding a weight vector, encode the second electronic signal into a plurality of second light signals, and apply each of the plurality of second light signals to a different one of the plurality of light channels, thereby producing a plurality of combined light signals. The system includes a plurality of detectors configured to detect each of the plurality of combined light signals, and convert each of the plurality of combined light signals into an electronic signal. The first electro-optic modulator may comprise an electro-optic crystal. The electro-optic crystal may include lithium niobate. The plurality of second electro-optic modulators may each comprise an electro-optic crystal. The electro-optic crystal may include lithium niobate. The first electro-optic modulator may further be configured to encode the first electronic signal using amplitude modulation. The plurality of second electro-optic modulators may be configured to encode the second electronic signal using amplitude modulation.

In various embodiments, a method of performing a matrix-vector-multiplication operation in an artificial neural network is provided. A first electronic signal encoding a data vector is received. A second electronic signal encoding a weight vector is received. The first electronic signal is encoded into a first light signal. The first light signal is spatially fanned-out, into different spatial modes and into a plurality of light channels. The second electronic signal is encoded into a plurality of second light signals. Each of the plurality of second light signals is applied to a different one of the plurality of light channels, thereby producing a plurality of combined light signals. Each of the plurality of combined light signals is detected. The detected plurality of combined light signals is converted into electronic form, thereby producing at least a portion of a result of a matrix-vector-multiplication operation. The encoding the first electronic signal may include modulating the first electronic signal using amplitude modulation. The encoding the second electronic signal may include modulating the second electronic signal using amplitude modulation. The plurality of combined light signals may be summed.

In various embodiments, a system for performing a matrix-vector-multiplication operation in an artificial neural network is provided. The system includes an electro-optic modulator configured to receive a first electronic signal encoding a data vector, encode the first electronic signal into a first light signal, and spatially fan-out, into different spatial modes, the first light signal into a plurality of light channels. The system includes a plurality of electro-optic amplitude attenuators configured to receive a second electronic signal encoding a weight vector, encode the second electronic signal into a plurality of second light signals, and apply each of the plurality of second light signals to a different one of the plurality of light channels, thereby producing a plurality of combined light signals. The system includes a plurality of optical delay lines configured to delay each of the plurality of combined light signals using a different delay amount. The system includes a plurality of phase shifters configured to phase shift each of the delayed plurality of combined light signals to produce a plurality of phase shifted light signals. The system includes at least one photodetector configured to detect the plurality of phase shifted light signals, and convert the plurality of detected, phase shifted light signals into electronic form. The electro-optic modulator may comprise an electro-optic crystal. The electro-optic crystal may include lithium niobate. The plurality of electro-optic amplitude attenuators may each comprise an electro-optic crystal. The electro-optic crystal may include lithium niobate. The electro-optic modulator may further be configured to encode the first electronic signal using amplitude modulation. The plurality of electro-optic amplitude attenuators may be configured to encode the second electronic signal using amplitude modulation.

In various embodiments, a method of performing a convolution operation in an artificial neural network is provided. A first electronic signal encoding a data vector is received. A second electronic signal encoding a weight vector is received. The first electronic signal is encoded into a first light signal. The first light signal is spatially fanned-out into different spatial modes and into a plurality of light channels. The second electronic signal is encoded into a plurality of second light signals. Each of the plurality of second light signals is applied to a different one of the plurality of light channels, thereby producing a plurality of combined light signals. Each of the plurality of combined light signals is delayed using a different delay amount. Each of the delayed plurality of combined light signals is phase shifted to produce a plurality of phase shifted light signals. The plurality of phase shifted light signals is detected. The plurality of detected, phase shifted light signals is converted into electronic form, thereby producing at least a portion of a result of a convolution operation. The encoding the first electronic signal may include modulating the first electronic signal using amplitude modulation. The encoding the second electronic signal may include modulating the second electronic signal using amplitude modulation.

In various embodiments, a digital-to-analog converter is provided. The system includes a plurality of electro-optic modulators coupled in series, each modulator is configured to receive a digital electronic signal. Each of the plurality of modulators outputs signals of a different wavelength. The system includes a photodetector confiugred to receive the output of the plurality of modulators, and convert the output into electronic form. The plurality of modulators may each comprise an electro-optic crystal. The electro-optic crystal may include lithium niobate.

### BRIEF DESCRIPTION OF THE DRAWINGS

FIG. 1 shows a photonic matrix-vector-multiplication (MVM) processor on thin-film lithium niobate according to various embodiments of the present disclosure.

FIG. 2 shows various integrated heterogeneous thin-film lithium niobate (TFLN) circuits and TFLN components for photonic computing according to various embodiments of the present disclosure.

FIGS. 3A-3E show ultrafast and low power consumption photonic matrix-vector-multiplications performed using a photonic matrix-vector-multiplication (MVM) processor on thin-film lithium niobate (TFLN) and the results of experiments performed using the processor according to various embodiments of the present disclosure.

FIGS. 4A-4C show the results of experiments performed using a photonic matrix-vector-multiplication (MVM) processor for photonic classification for data points in a two-dimensional plane according to various embodiments of the present disclosure.

FIGS. 5A-5C show matrix-vector-multiplications for fully connected layers of a photonic neural network used for image recognition of MNIST handwritten digits using a photonic matrix-vector-multiplication (MVM) processor according to various embodiments of the present disclosure.

FIG. 6 shows a photonic convolutional neural network accelerator implemented on on thin-film lithium niobate (TFLN) according to various embodiments of the present disclosure.

FIG. 7 shows a digital electronics (DE) to analog-photonics (AP) modulator according to various embodiments of the present disclosure.

FIG. 8 is a flow diagram of an example process for performing a matrix-vector-multiplication operation for artificial neural network processing according to various embodiments of the present disclosure.

FIG. 9 is a flow diagram of an example process for performing a convolution operation for artificial neural network processing according to various embodiments of the present disclosure.

FIG. 10 depicts a computing node according to various embodiments of the present disclosure.

FIG. 11A-11C depict a photonic matrix-vector-multiplication (MVM) accelerator on thin-film lithium niobate according to various embodiments of the present disclosure.

FIGS. 12A-12H depict an integrated thin-film lithium lithium niobate photonic circuit according to various embodiments of the present disclosure.

FIGS. 13A-13D depict high-speed and energy-efficient photonic matrix-vector-multiplications on thin film niobate according to various embodiments of the present disclosure.

FIGS. 14A-14C depict photonic binary classification according to various embodiments of the present disclosure.

FIGS. 15A-15D depict matrix-vector-multiplications for fully-connected layers of photonic neural networks according to various embodiments of the present disclosure.

FIG. 16 depicts propagation loss characterization, in accordance with various embodiments.

FIG. 17 depicts on-chip terminator designs, in accordance with various embodiments.

FIG. 18 depicts a grating coupler design, in accordance with various embodiments.

FIG. 19 depicts calibration, in accordance with various embodiments.

FIG. 20 depicts computational accuracy for different speeds, in accordance with various embodiments.

FIG. 21 depicts a comparison of speed and energy consumption, in accordance with various embodiments.

### DETAILED DESCRIPTION

Neural networks may be implemented using photonics, such as a photonic processor and/or accelerator, which may provide many advantages over the use of conventional electronic computer processors and may help to resolve the issues surrounding the use of these conventional processors. The advantages of using such photonics may include a high bandwidth because of the use of a high carrier frequency in light, the carrying out of operations passively in photonics as opposed to actively such as in electronic computer processors, a low latency as compared to electronic computer processors, and parallel processing. For example, a photonic neural network (PNN) and/or a photonic convolutional neural network (PCNN) may be used to perform artificial neural network operations. A PNN and/or PCNN may allow for a high-bandwidth of operations as compared to conventional electronic computer implemented ANNs. This may be due to the use of optics and the ability of the optical and/or electro-optic components within such PNN and/or PCNNs to process linear operations passively. In addition, such performance of operations passively may allow for very low power consumption as compared to conventional electronic computer implemented ANNs.

Particular aspects of A PNN and/or PCNN may use electro-optic components to interface with an electronic computer. For example, electronic signals may be generated by the electronic computer, converted to optical signals by the electro-optic components, processed by the optical and/or electro-optic components, and then possibly converted back into electrical signals. In particular, for example, the PNN and/or PCNN may use components such as an electro-optic modulator, for example, an amplitude modulator, to convert electronic data signals into the optical domain. Such electro-optic components may include electro-optic crystal, such as lithium niobate, lithium tantalite, potassium titanyl, phosphate, β-barium borate, and/or the like. Thus, an electro-optic crystal may be used to implement the electro-optic components of the PNN and/or PCNN instead of silicon photonics. Such use of electro-optic components implemented using electro-optic crystal may simultaneously provide for a high bandwidth for computations/operations, a low Vpi, and a low insertion loss as compared to silicon photonics when used in an application such as a high-speed and low-power-consumption PNN and/or PCNN. For example, electro-optic conversion using a TFLN modulator may have a Vpi of approximately 1V, and may have a EO bandwidth of greater than 100 GHz.

A PNN may use a static kernel matrix encoded on-chip. If the PNN is implemented using silicon photonics, the static kernel matrix may be applied using thermal heaters, which may have a large dissipative power consumption. In contrast, if the PNN is implemented using an electro-optic crystal, such as lithium niobate, the static kernel matrix may be applied using static electro-optic (DC) tuning, which may have a low power consumption when compared to the use of thermal heaters. For example, such capacitive tuning may consume close to no power.

Multiple schemes are described herein for implementing a PNN and/or PCNN on an electro-optic crystal, such as thin-film lithium niobate. Each of the schemes may be used as an accelerator for neural network operations, such as matrix-vector-multiplication (MVM) operations. For example, in a first scheme, a PNN accelerator may be implemented using a cascaded modulator approach to best implement PNN operations, such as MVM operations. As another example, in a second scheme, a PCNN accelerator may be implemented using the combination of a modulator, an attenuator, a delay line, and a phase shifter approach to best implement PCNN operations, such as convolution operations.

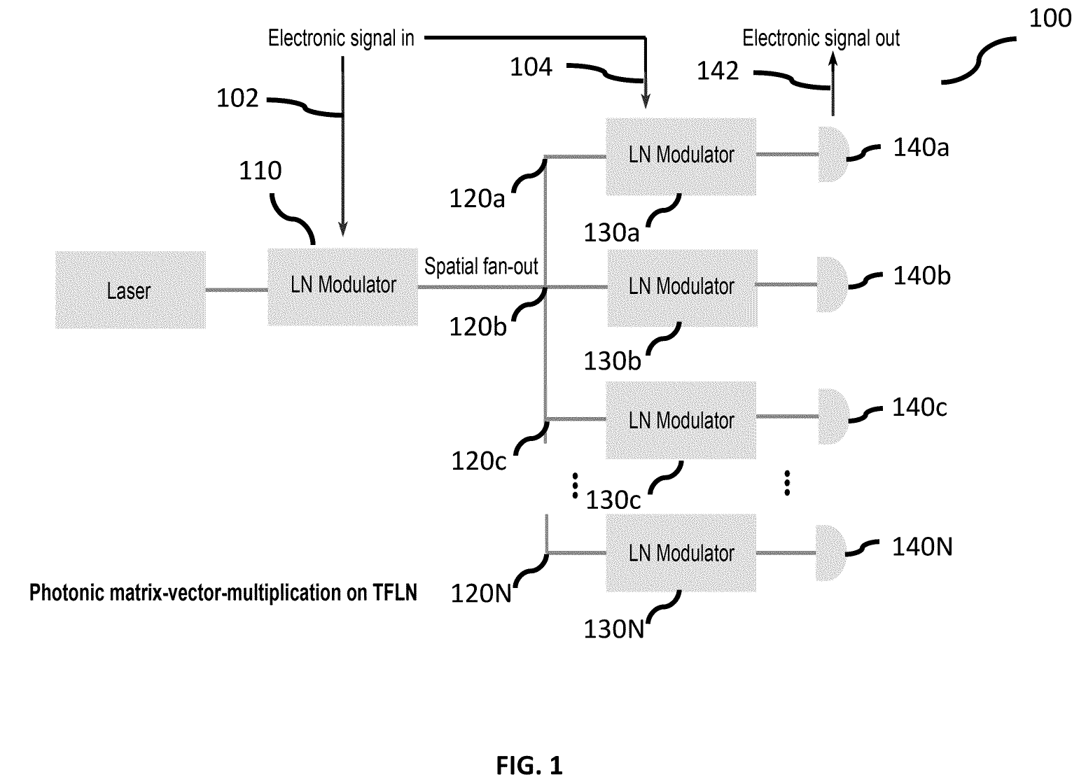

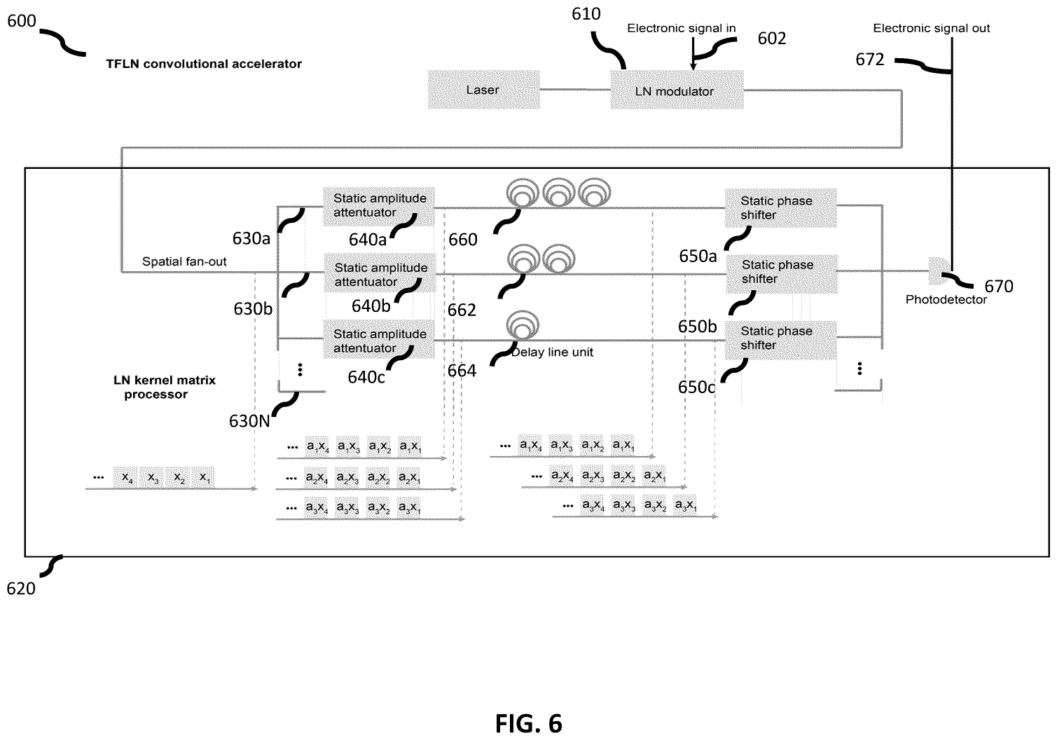

As a first scheme, a fully integrated photonic MVM processor, aspects or all of which may be implemented using an electro-photonic crystal, such as heterogeneous thin-film lithium niobate, is described and demonstrated herein. A working principle of the photonic MVM processor may include using at least two amplitude modulators to encode the data of an input vector, such as an input data vector associated with an artificial neural network, and weights of a neuron, such as a neuron associated with an artificial neural network, in the time domain. The working principle of the MVM processor may further include multiplying the input vector and weights together by cascading the at least two modulators in series. Such a photonic MVM processor, as described herein, may be able to convert electronic data, such as in an electronic signal, into the optical domain, such as a light signal, with high speed and low loss. The photonic MVM processor may also have a stable and low power consumption with neural network weights encoded on chip. The photonic MVM processor, as described herein, may further be efficient and its components may be capable of high-speed electro-optic conversion. FIG. 1 shows aspects of such a photonic MVM processor 100 using the aforementioned working principles. As a second scheme, a photonic convolutional neural network accelerator, aspects or all of which may be implemented using an electro-photonic crystal, such as heterogeneous thin-film lithium niobate, is described and demonstrated herein. FIG. 6 shows aspects of such a photonic convolutional neural network accelerator 600.

FIG. 1 shows a photonic matrix-vector-multiplication (MVM) processor 100 on thin-film lithium niobate. At a high level, by spatially multiplexing different neurons using light signals, a matrix-vector multiplication may be performed. The MVM processor 100 may receive an input data vector, associated with activation data for an artificial neural network, as well as a weight vector from a matrix of weights, associated with weights for the artificial neural network, encoded in the form of electronic signals 102 and 104, respectively. These signals may each be from an electronic computing system and/or node (not shown). In various embodiments, the input electronic signal 102, encoding a data vector, may be modulated and thus encoded in the time domain into a light signal using an amplitude modulator, such as electro-optic amplitude modulator 110. In particular, an amplitude modulator, such as electro-optic amplitude modulator 110, may receive the electronic signal 102. The amplitude modulator, such as electro-optic amplitude modulator 110, may modulate and thus encode in the time domain the received electronic signal 102 into a light signal. Then, this light signal may be spatially fanned-out, by the amplitude modulator, such as electro-optic amplitude modulator 110, into different spatial modes or light channels 120, which each may represents one neuron of an artificial neural network. In particular, the light signal output by the amplitude modulator, such as electro-optic amplitude modulator 110, may be fanned-out into multiple light signals, each light signal being on different spatial light channel 120. The electronic signal 104, encoding a weight vector, may be modulated and thus encoded into multiple light signals using one or more amplitude modulator(s), such as electro-optic amplitude modulators 130, to be multiplied with the input data. In particular, for each light channel 120, an amplitude modulator, such as electro-optic amplitude modulator 130, may receive at least a portion of the electronic signal 104, encoding a weight vector associated with the weights for the artificial neural network. The received at least portion of the electronic signal 104 may be modulated and thus encoded into a second light signal by each amplitude modulator, such as electro-optic amplitude modulator 130, on each light channel 120. Each amplitude modulator, such as electro-optic amplitude modulator 130, on each light channel 120 may then apply its associated second light signal to the light on its associated light channel 120 to produce, as output, a combined light signal on that associated light channel 120.

Each photodetector 140, on each light channel 120, may detect the combined light signal output by the amplitude modulator, such as electro-optic amplitude modulator 130, on each light channel 120 and convert the result back into an electronic signal 142, which may be an analog electronic signal. This resulting electronic signal may represent at least a portion of an MVM operation. The electronic signal may be output into electronics and/or may be summed up and may be output into electronics. Any of modulator(s) described in relation to FIG. 1, such as electro-optic modulator 110 and/or electro-optic modulator(s) 130, may include electro-optic crystal, such as lithium niobate, lithium tantalite, potassium titanyl, phosphate, β-barium borate, and/or the like. Any of modulator(s) described in relation to FIG. 1, such as electro-optic modulator 110 and/or electro-optic modulator(s) 130, may use amplitude modulation to encode its input/received signal.

In the experiments described herein, the integrated photonic MVM processor is constructed by combining various state-of-the-art thin-film lithium niobate (TFLN) components as well as a laser and a detector integrated to TFLN. In addition, the processor used the scheme that took advantage of the high-speed and efficient TFLN modulator as well as strong electro-optic (EO) components for DC tuning.

The photonic MVM processor, described herein, may represent the most complicated TFLN circuit to date. In various embodiments, the processor may include greater than or less than 100 components, including 16 modulators, 1 multimode-interferometer tree (15 MMIs), 32 heater, 32 heater routing lines, 16 terminator, 18 grating couplers, and/or 1 photonic wire bonding integrated together, though any number of such components may be integrated together.

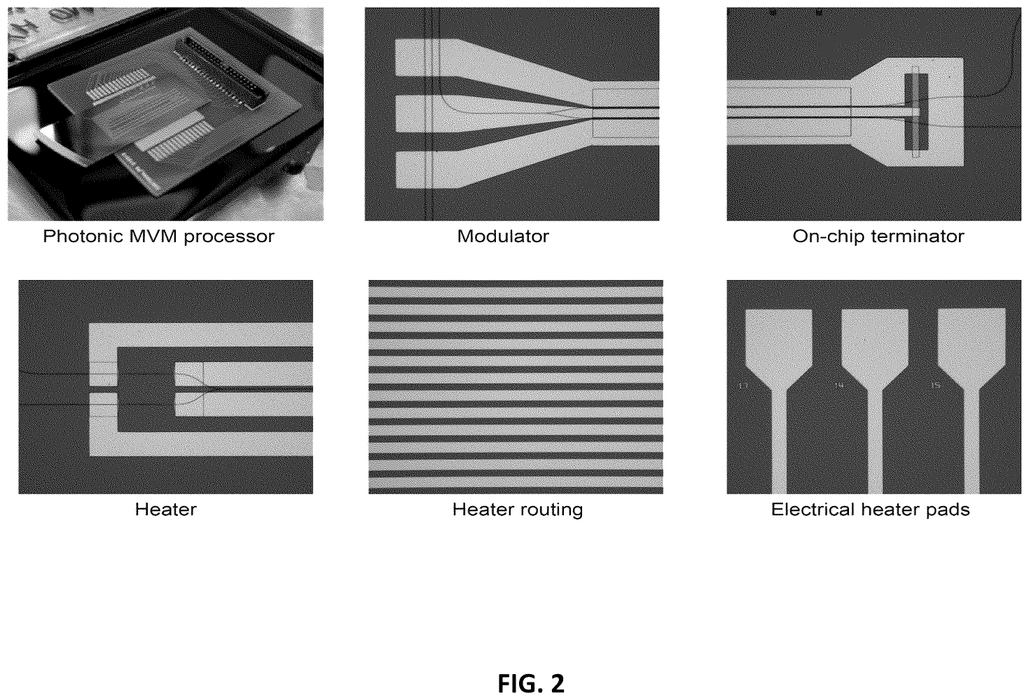

FIG. 2 shows various integrated heterogeneous thin-film lithium niobate (TFLN) circuits and TFLN components for photonic computing. The photonic-circuit and photonic component images shown in FIG. 2 include: a photonic MVM processor, a modulator, an on-chip terminator, a heater, heater routing, and electrical heater pads, as labeled.

In the experiments described herein, to demonstrate a fully integrated heterogenous TFLN processor as shown in FIG. 2, the TFLN chip including the processor was first fabricated with a modulator, MMIs, heater, terminator, and a mode converter. III-V material was then bonded to the TFLN chip and a photodetector was fabricated. The TFLN chip was further integrated with a laser through a photonic wire-bonding. Finally, electronic pads were wire-bonded to the printed circuitry board (PCB), which included the chip, in order perform the final optical-electronic co-packaging.

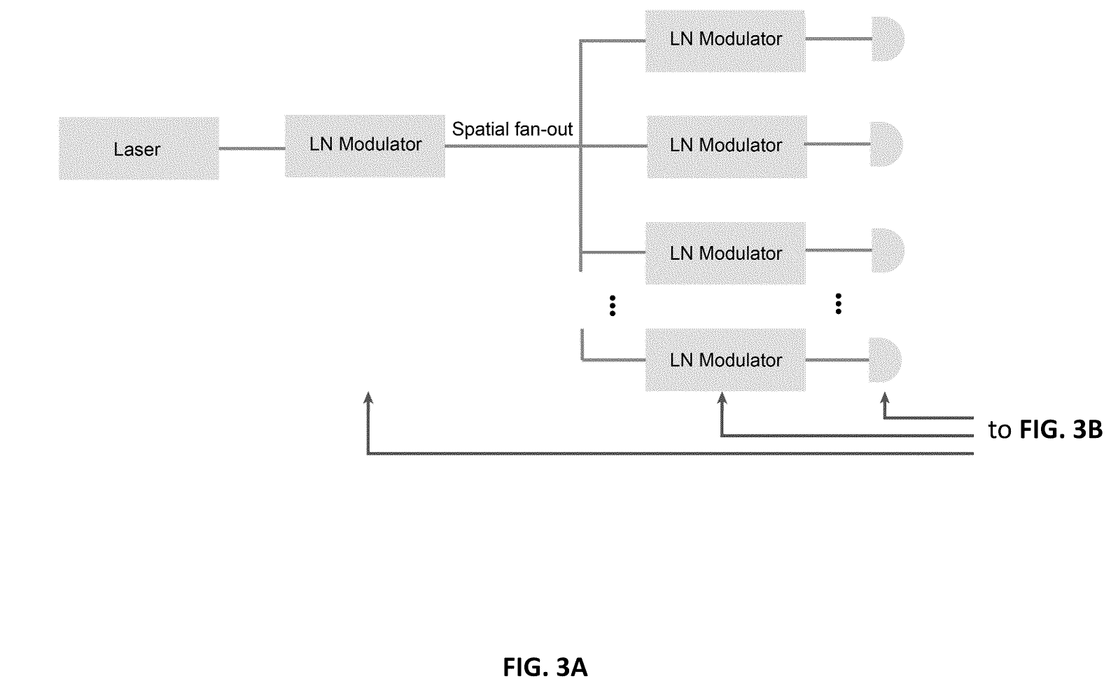

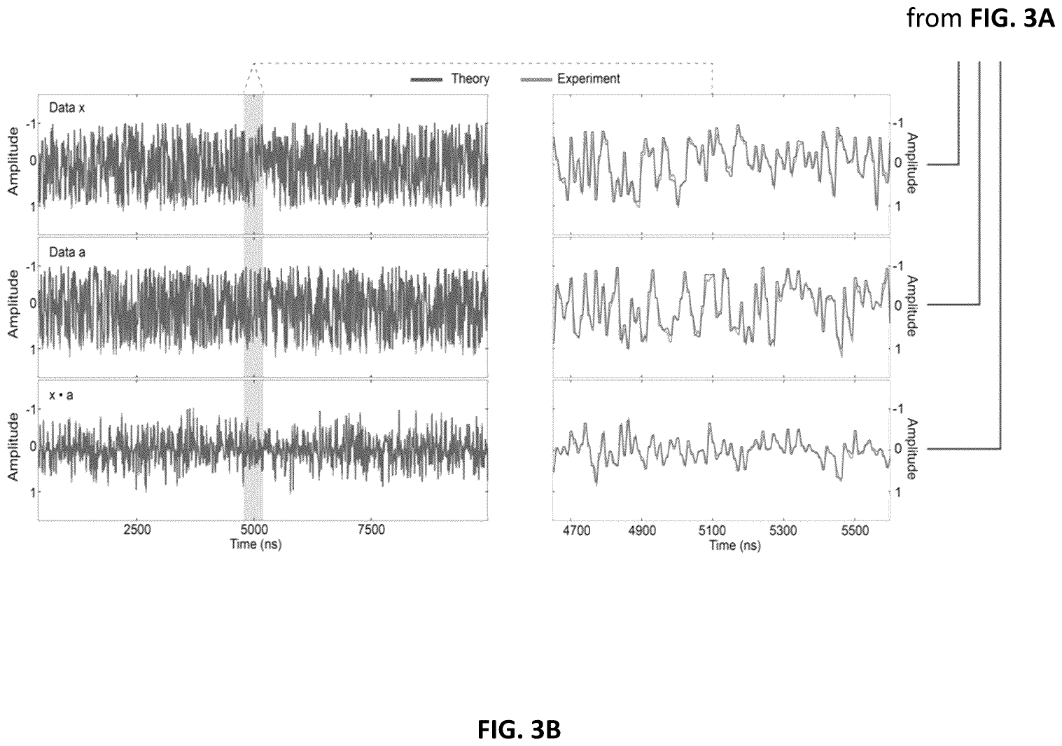

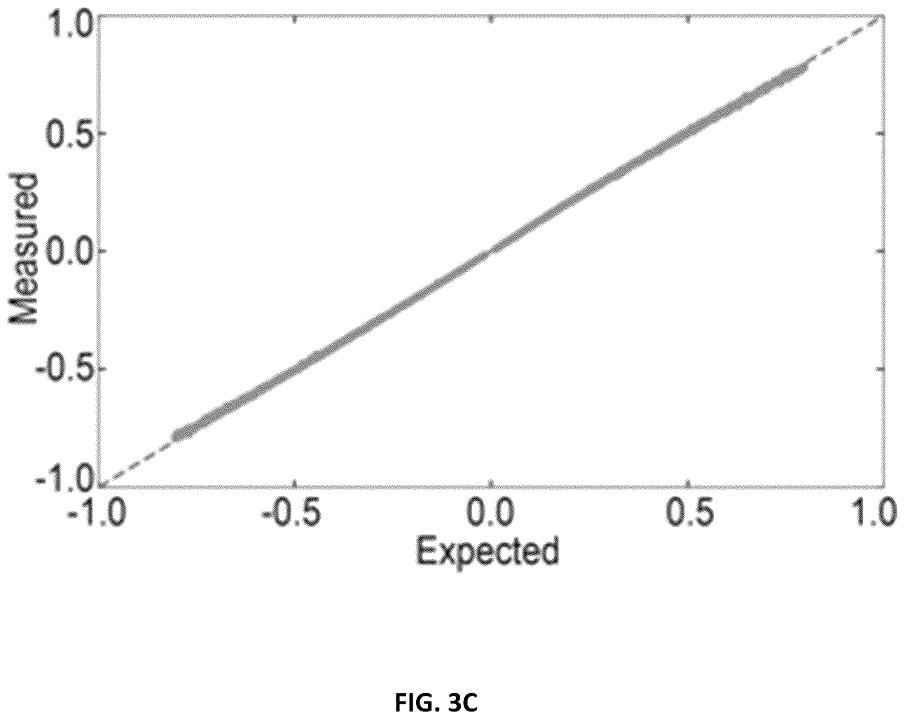

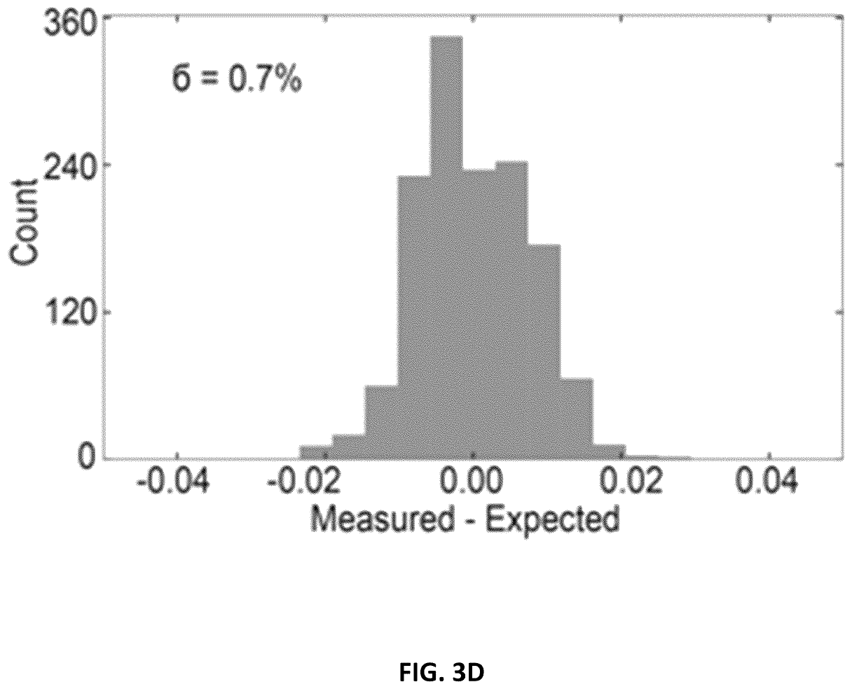

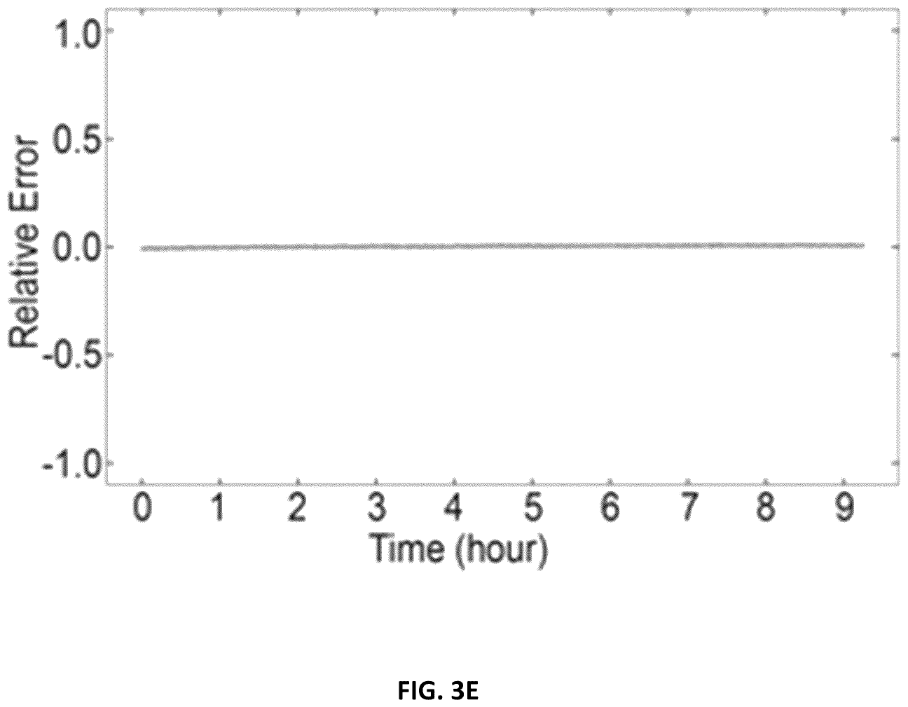

FIGS. 3A-3E show ultrafast and low power consumption photonic matrix-vector-multiplications performed using a photonic matrix-vector-multiplication (MVM) processor on thin-film lithium niobate (TFLN) and the results of experiments performed using the processor. FIG. 3A shows a 2D illustration of the structure of the photonic MVM processor, such as photonic MVM processor 100. FIG. 3B shows an example waveform of experiments conducted by performing an MVM multiplication operation for a random data vector \vec{x} and a random weight vector \vec{a} in the time-domain. FIG. 3C shows the computational accuracy for the MVM operations performed in the experiments conducted using the random vectors as in FIG. 3B. FIG. 3D shows a histogram of the computational accuracy referred to in FIG. 3C, where the histogram shows a standard deviation of 0.7%. FIG. 3E shows the stability of a single MVM operation based on the relative error of the computation involved in the performance of the operation. In relation to FIG. 3E, a single MVM operation was repeated continuously for over 9 hours and the standard deviation of relative error was found 0.47%.

In the experiments described in relation to FIG. 3, photonic MVM operations were demonstrated on a photonic MVM processor. The results showed that the processor was able to operate at a high-speed and with low power consumption. In particular, in these experiments, random data vectors with a length of 1024 were used for both the input data vectors as well as the vector of weights of a neuron (i.e., weight vector or neuron weight vector). The input data vector and neuron weight vector were encoded into light signals in the time domain. These vectors were multiplied, using the techniques described herein, after the light signals associated with each of the vectors passed through at least one of two modulators, such is what is described in relation to FIG. 1. As shown in FIG. 3B, the results of the experiments demonstrated excellent agreement with the theory. As shown in FIG. 3C, the computational accuracy of the results of the multiplications in the experiments were further tested by comparing the expected MVM operation results with the measured results. As shown in FIG. 3D, the histogram of the data collected from the experiments revealed a standard deviation of 0.7% for the MVM operation conducted.

Stability may be a key metric for photonic devices, such as for optical computing processors. The efficient electro-optic (EO) effect on TFLN may allow DC biasing on such photonic devices. Such DC biasing consumes negligible static power. However, due to a photorefractive and photovoltaic effect, TFLN may have a DC bias drift. As a result, many lithium niobate (LN) modulators, for example in a data center, use a thermal bias, such as that provided by a heater, which may have a large amount of power consumption. One advantage of the integrated photonic MVM processor described herein may be that a DC bias may be periodically turned off after each MVM operation for an ultrashort time interval, such as a nanosecond to millisecond, which may effectively provide a time-varying bias that can address DC drift. In the experiments described herein, as shown in FIG. 3E, the stability of the integrated photonic MVM processor device was tested with DC bias by repeating the same MVM operation continuously for a period greater than 9 hours. In such experiments, the photonic MVM processor device featured substantial stability with a relative error of 0.47%.

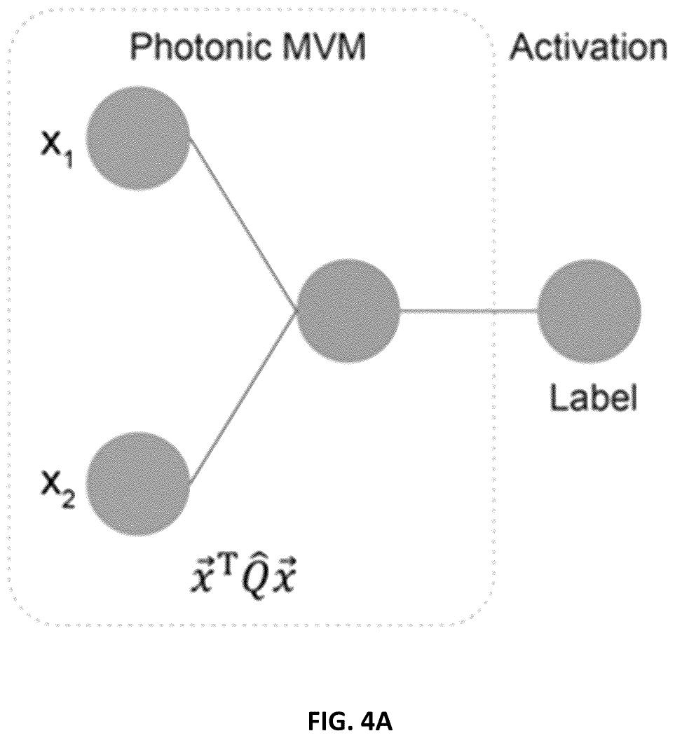

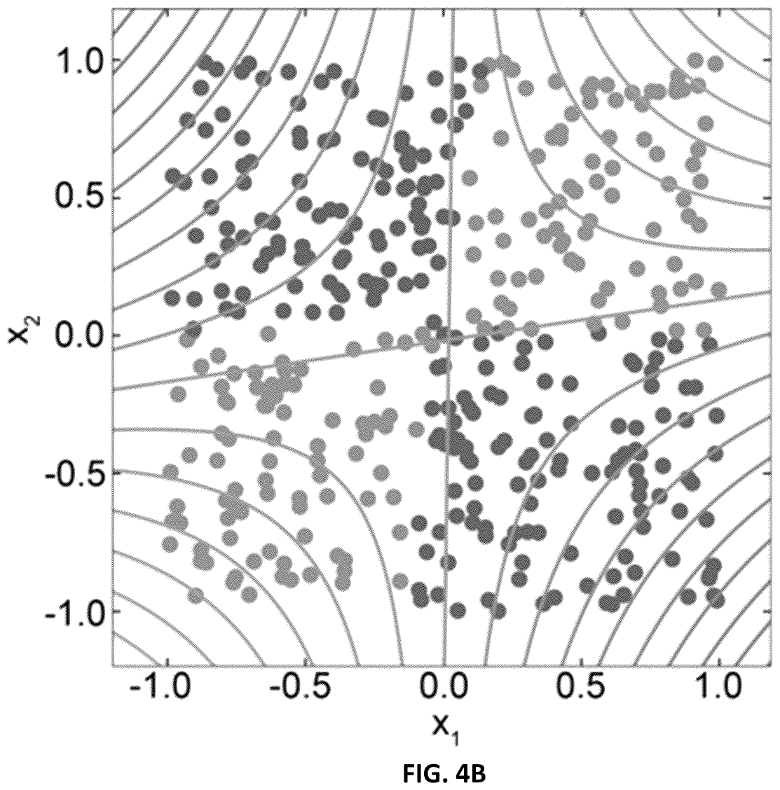

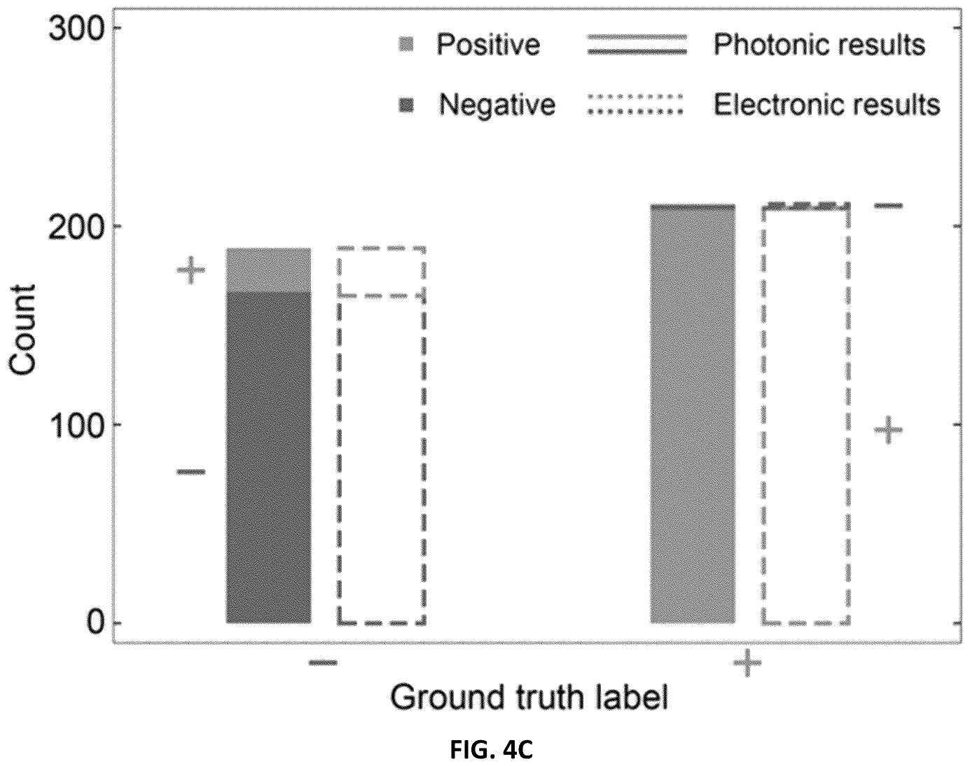

FIGS. 4A-4C show the results of experiments performed using a photonic matrix-vector-multiplication (MVM) processor for photonic classification for data points in a two-dimensional plane. FIG. 4A shows an Illustration of the classification problem for points in a two-dimensional plane. FIG. 4B shows classification results for experiments conducted on 400 data points using the photonic MVM processor for photonic classification of the data points in a two-dimensional plane. FIG. 4C shows statistical results of the classification performed in the experiments described in relation to FIG. 4B.

In the experiments described herein, to test the performance of the photonic MVM processor for its application to computer vision, the integrated photonic MVM processor device was applied to a mathematical problem for classification of data points in a two-dimensional plane. In particular, as shown in FIG. 4A, the data point

$$\vec{x} = ( \begin{matrix}{x}_{1} \\ {x}_{2}\end{matrix} )$$

was sent into the photonic MVM processor device and a linear transformation was applied followed by a nonlinear activation to obtain a label. The positive or negative sign of the result, which was regarded as the label, indicated the category of each data point. A total number of 400 such data points were tested and the classification results are shown in FIG. 4B in a 2D plane. The overall accuracy for this classification task was 93.8%, whereas the overall accuracy for the same classification task was 93.5% on an electronic computer, which did not use the photonic techniques described herein. As shown in FIG. 4C, the histogram of the classification results indicates an accuracy of 98.6% and 88.4% for the data points with positive ground truth and negative ground truth, respectively. For comparison, as shown in FIG. 4C, the histogram of the classification results indicates an accuracy of 99.1% and 87.3% for the data points with positive ground truth and negative ground truth, respectively, on an electronic computer, which did not use the photonic techniques described herein. It should be noted that an electronic computer, such as the one used for comparison in the experiments described herein, may be less energy inefficient, may have a higher latency, and may be more bandwidth limited when compared to the integrated photonic MVM processor device as described herein.

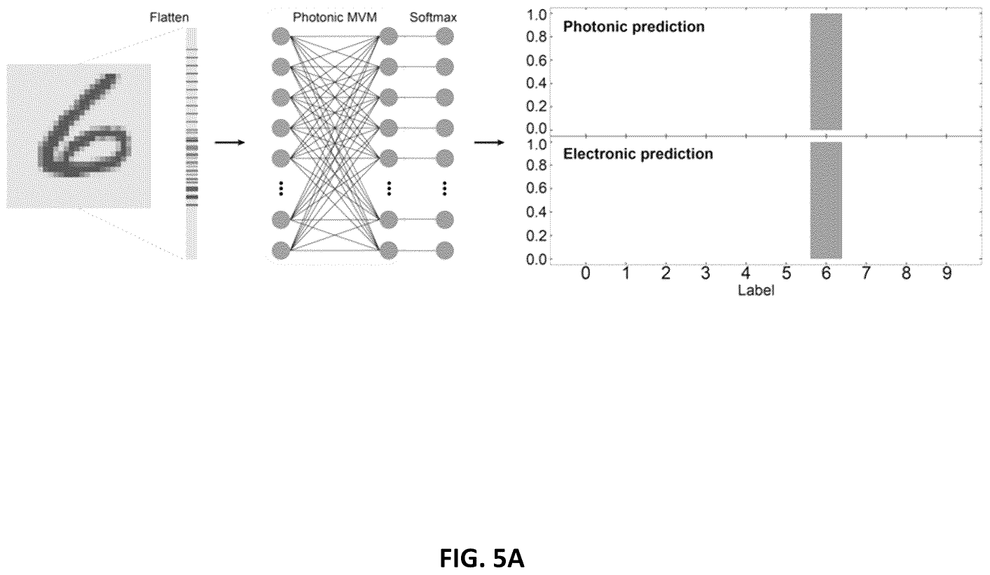

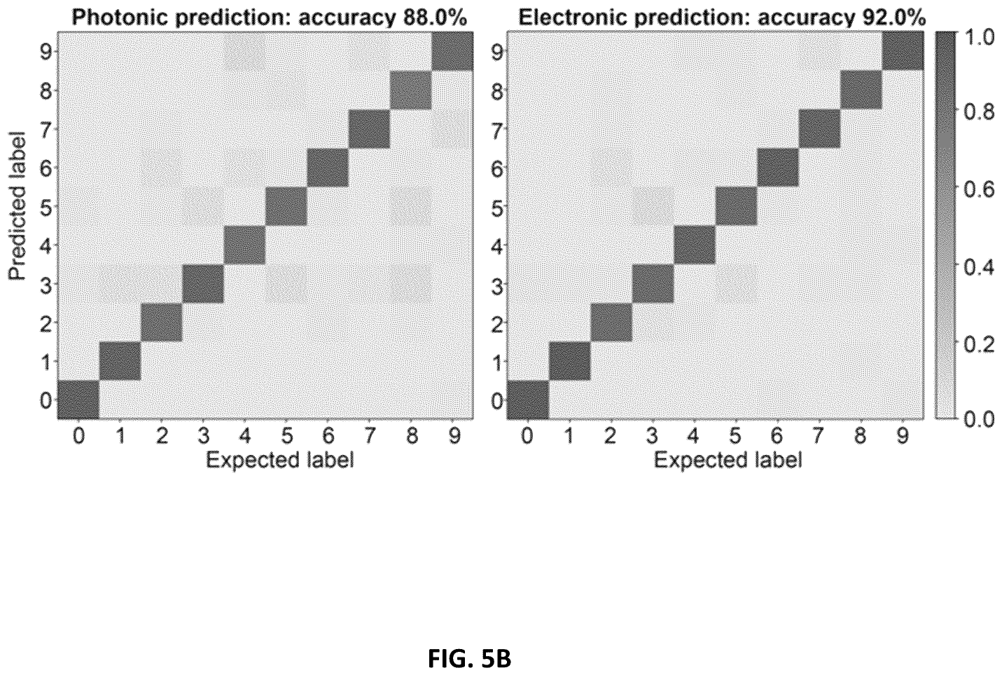

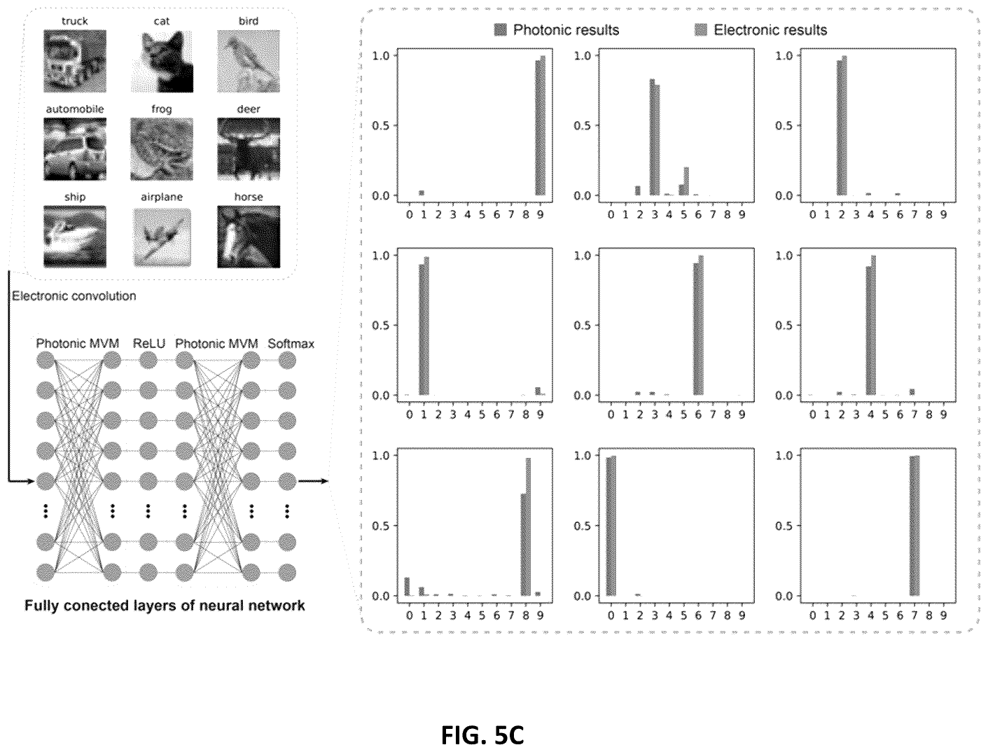

FIGS. 5A-5C show matrix-vector-multiplications for fully connected layers of a photonic neural network used for image recognition of MNIST handwritten digits using a photonic matrix-vector-multiplication (MVM) processor, such as photonic MVM processor 100, as described herein. In particular, in the experiments described herein, a photonic neural network was demonstrated on the MNIST dataset for handwritten digit classification using the integrated photonic MVM processor device as described herein. FIG. 5A shows the results of image classification experiments for a single MNIST handwritten digit on a photonic MVM processor as well as on an electronic computer. As shown in FIG. 5A, the image of the MNIST handwritten digit was flattened as a single vector encoded in time domain and sent into the photonic MVM processor. A two-layer photonic neural network was used to perform the classification/recognition task. In this neural network, the number of neurons for the first neural network layer was 784 and the number of neurons for the second neural network layer was 10. The MNIST image was sent as input to the processor to perform a linear transformation based on the neural network. The output neuron results of the photonic MVM processor were then sent back to an electronic computer to perform a nonlinear activation via a Softmax function. As shown in FIG. 5A, the final classification results were consistent with a similar classification/recognition task that was performed using solely an electronic computer, without the use of photonics. FIG. 5B shows statistic results of and MNIST digit handwriting classification/recognition experiment performed on multiple images using the photonic MVM processor, such as MVM processor 100 described herein, as well as on an electronic computer without photonic components. In the experiment associated with FIG. 5B, 500 MNIST images were tested and the confusion matrix, as shown in FIG. 5B, indicates excellent results for classification. The results show that there was an accuracy of 88% for the photonic MVM processor and 92% using the electronic computer, which did not include photonic components or use the photonic techniques described herein. This indicates that the photonic MVM processor can perform the MVM operation efficiently for a neural network algorithm.

In the experiments described herein, to further qualify the performance on solving real problems, classification using the integrated photonic MVM processor device was demonstrated on real images. FIG. 5C shows images and a neural network used for an experiment in which classification/recognition of real images was tested. FIG. 5C also shows the results of the experiment. This experiment went beyond classification/recognition of handwritten digits. As shown in FIG. 5C, real images were extracted from the CIFAR-10 database and classified/recognized using a convolutional neural network. The extracted real images were first processed with a convolution layer using an electronic computer. The processing could have instead, in principle been implemented on TFLN using a convolutional accelerator design, such as the one shown in FIG. 6, which may have performed better than the electronic computer. The processed extracted real images were then sent as input to the photonic MVM processor, as described herein, to perform the operations of a three-layer fully connected neural network. The number of neurons for each layer of the three-layer fully connected neural network were 1024 neurons for the first neural network layer, 128 neurons for the second neural network layer, and 10 neurons for the third neural network layer. Images in 10 different categories were tested. FIG. 5C shows nine example figures together with the image classification/recognition results of the experiment used to classify images as one of the nine example figures. The nine example figures include a truck, a cat, a bird, an automobile, a frog, a deer, a ship, an airplane, and a horse.

FIG. 5C shows the classification performance results by the integrated photonic MVM processor device for the examples figures of a truck, a cat, a bird, an automobile, a frog, a deer, a ship, an airplane, and a horse. The results of this image classification/recognition task, which were excellent, were compared to the results of the same image classification/recognition task performed on an electronic computer, which did not include photonic components. As shown in FIG. 5C, the results indicate that the photonic MVM processor, as described herein, can perform computations over real images, and may have comparable performance to or outperform an electronic computer on image classification/recognition tasks.

FIG. 6 shows a photonic convolutional neural network accelerator 600 implemented on on thin-film lithium niobate (TFLN). To perform the photonic convolution operation, an input data vector may first be encoded in the time domain using a data electro-optic amplitude modulator 610. The resulting light signal may then be fanned out into different spatial light waveguides/channels 630. In each light waveguide/channel 630, an optical attenuation may be applied by a static electro-optic attenuator 640 to adjust the amplitude of light. Optical delay lines 660, 662, and 664 may be implemented on each waveguide/channel 630 to achieve a spatial-time interleave of the data. The different waveguides/channels 630 may be combined again and the combined light may be sent to the photodetector 670. The output 672 of photodetector 670 may be a result of a convolution operation. This convolution operation result may be achieved with a high-speed and a low power consumptions on TFLN. Any component described in relation to FIG. 6, such as electro-optic modulator 610 and/or electro-optic attenuator(s) 640, may include electro-optic crystal, such as lithium niobate, lithium tantalite, potassium titanyl, phosphate, β-barium borate, and/or the like. Any of modulator(s) or attenuator(s) described in relation to FIG. 6, such as electro-optic modulator 610 and/or electro-optic attenuator(s) 640, may use amplitude modulation to encode its input/received signal. In particular, FIG. 6 shows a design of a convolution accelerator 600 used to perform a convolution operation. Because the convolution operation underpins many of the applications in image recognition, the convolution accelerator 600 may be used to deal with the possible applications of convolution on, for example, TFLN. The design of the convolution accelerator 600 takes advantage of the high speed, low power consumption, low loss, and strong EO components of the TFLN platform. In the design of convolution accelerator 600, a data electro-optic amplitude modulator 610 may receive electronic signal 602, encoding an artificial neural network input data vector, and may encode this signal into a light signal in the time domain. The resulting light signal may then be sent into a electro-optic kernel processor 620 in which the light may be fanned-out into different spatial modes and into different spatial light channels 630. Each light channel 630 may contain a static electro-optic amplitude attenuator 640 and a static phase shifter 650 that may apply DC tuning to respectively adjust the amplitude and phase of the light signal on that channel. Each static electro-optic attenuator 640 may receive an electronic signal, encoding a weight vector and associated with artificial neural network weights, and encode the electronic signal into multiple light signals. Each static electro-optic attenuator 640 may apply each of these light signals to a different one of the light channels 630 and thus to the light on that channel, thereby producing multiple combined light signals. Different lengths of optical delay line, such as optical delay lines 660, 662, and 664, may be used in each channel 630 to delay each of the multiple combined light signals and to achieve a spatial-time interleave to perform a convolution operation. The static phase shifters 650 in each path may be applied to each channel 630 to phase shift each of the delayed multiple combined light signals and to ensure that all the different waveguides/light channels 630 can have constructive interference when combined together. The static phase shifters 650 may also be used to perform more complex convolutional neural network operations by varying the static phase shift. The light from the multiple phase-shifted, delayed, and combined light signals may then be detected and summed into one spatial mode and converted back into electronic domain, such as in the form of an analog electronic signal 672, using a photodetector 670. The advantage of this proposed scheme may be that only one high-speed electro-optic modulator, such as a TFLN modulator, may be used to encode the data with all other components in quasi-static state. This may greatly reduce the complexity of any electronic circuits that may be used alongside or in conjunction with design of the convolution accelerator 600. The use of DC tuning for the electro-optic kernel processor 620 may allow for ultra-low power consumption compared to the use of a a conventional modulator or conventional phase change materials. In this proposed scheme of FIG. 6, conventional wavelength multiplexing may be avoided due to a possible lack of low power consumption, and often, a high power consumption, associated with using wavelength division multiplexing (WDM) in the platforms involving the use of integrated photonics. In various embodiments, an energy efficient WDM scheme may be applied on electro-optic materials, such as TFLN, using the strong EO tuning, demonstrated herein, using a multi-resonator bank structure. With such a high-performance WDM, the convolutional operation, described herein, as well as the MVM operation for a fully connected neural network, described and demonstrated in the experiments described herein, can be combined. These operations may be able to take full advantage of time, spatial, and frequency multiplexing, which may be implemented on a superior photonic processing unit on electro-optic materials, such as one described herein.

Many electronic computer systems and electronic applications use digital electronics. In electro-optic applications, the digital electronic signals associated with such digital electronics have to be converted into optical signals. Conventionally, the link between photonics and electronics may be made using an electro-optic modulator, which may convert an analog electronic signal input to an optical signal output. In using such conventional electro-optic modulators, when attempting to connect with optical components, an electronic digital-to-analog converter (DAC) may have to be applied to the digital electronic signal to convert it to an analog electronic signal before it is input to the conventional electro-optic modulator. Such use of a DAC prior to the conventional electro-optic modulator may be inefficient, may increase latency, and may have a high power consumption. Therefore, there is a need for electro-optic modulators that do not rely on the use of such a DAC.

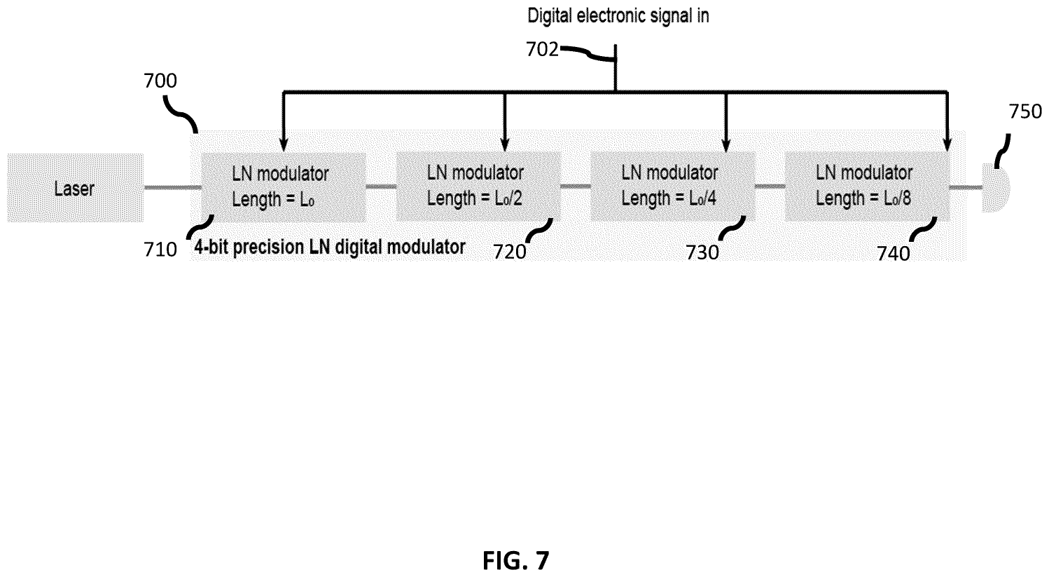

A photonic digital modulator 700, as shown in FIG. 7, may directly accept a digital electronic signal and convert it to analog optical signal, without the need for a DAC. Photonic digital modulator 700 may function more efficiently, at a very high speed, and at a very low power consumption when compared to a conventional electro-optic modulator. In various embodiments, together with a laser and a photo-detector, the modulator 700, as shown in FIG. 7, may also function as an electronic DAC, which would convert a digital electronic signal to an analog electronic signal, at very high speed and very low power consumption.

In particular, FIG. 7 shows a digital electronics (DE) to analog-photonics (AP) modulator 700. DE to AP modulator 700 may be used to convert a digital electronic signal input to an analog optical signal output. DE to AP modulator 700 may include one or more modulators, such as LN modulators 710, 720, 730, and 740 optically coupled together in series, as shown. There may be more or fewer modulators than those shown in in DE to AP link 700 of FIG. 7. Each of the modulators included in DE to AP modulator 700, such as electro-optic modulators 710, 720, 730, and 740, may produce signals of a different wavelength. For example, electro-optic modulator 710 may output signals of a wavelength L₀, electro-optic modulator 720 may output signals of a wavelength L₀/2, electro-optic modulator 730 may output signals of a wavelength L₀/4, and electro-optic modulator 740 may output signals of a wavelength L₀/8. Each wavelength may be used to provide a different wavelength for each separate bit in the digital electronic signal input to DE to AP modulator 700. As shown and without limitation, DE to AP modulator 700 may be an example of a 4-bit precision LN digital modulator, although other bit precision LN digital modulators may be constructed using the principles described herein. DE to AP modulator 700 may optionally include photodetector 750. A digital electronic signal, such as digital electronic signal 702, which may include multiple bits, such as four different bits, may be input into DE to AP modulator 700. In various embodiments, these bits may be input separately. In various embodiments, these bits may be input together as a vector and may be separated internal to DE to AP modulator 700. After the light, such as the laser light as shown, passes through the multiple modulators, such as electro-optic modulators 710, 720, 730, and 740, of DE to AP modulator 700, the light signal may be effectively modulated into a digital electronic signal. In various embodiments, the output of DE to AP modulator 700 may be the modulated light signal, which may be an analog optical signal, which is output by the last electro-optic modulator, such as electro-optic modulator 740, in the series of modulators. Such an analog optical signal may useful in applications of optical neural networks, communications, and/or the like. In various embodiments, electro-optic amplitude modulator 110, electro-optic amplitude modulator(s) 130, electro-optic amplitude modulator 610, and/or statistic electro-optic amplitude attenuator(s) 640, described herein, may each be implemented by DE to AP modulator 700.

In various embodiments, the output of DE to AP modulator 700 may be optionally output a signal as input to photodetector 750. Photodetector 750 may output an analog electronic signal that may represent the analog electronic signal equivalent of the detected output light signal of DE to AP modulator 700. The analog electronic signal output by photodetector 750 may also be the analog electronic signal equivalent of the digital electronic signal input to DE to AP modulator 700, such as digital electronic signal 702. As presented herein, when the DE to AP modulator 700 is used together with a photodetector, such as photodetector 750, the system shown in FIG. 7 may be used as an electronic DAC. This electronic DAC may output the analog electronic signal equivalent of the digital electronic signal input to DE to AP modulator 700, such as digital electronic signal 702. This electronic DAC system may be able operate at high speeds, such as 100 GHz, which may be higher than the speed of any conventional electronic DAC. This electronic DAC may also operate with very low power consumption, for example, due to the thin-film lithium niobate modulators, such as electro-optic modulators 710, 720, 730, and 740, which may be highly energy efficient, and used within DE to AP modulator 700. Although the components of various embodiments described herein may be described as being implemented using lithium niobate, it is to be understood that any electro-optic crystal may be used to implement such components. Examples of such electro-optic crystals may include lithium niobate, lithium tantalite, potassium titanyl, phosphate, β-barium borate, and/or the like.

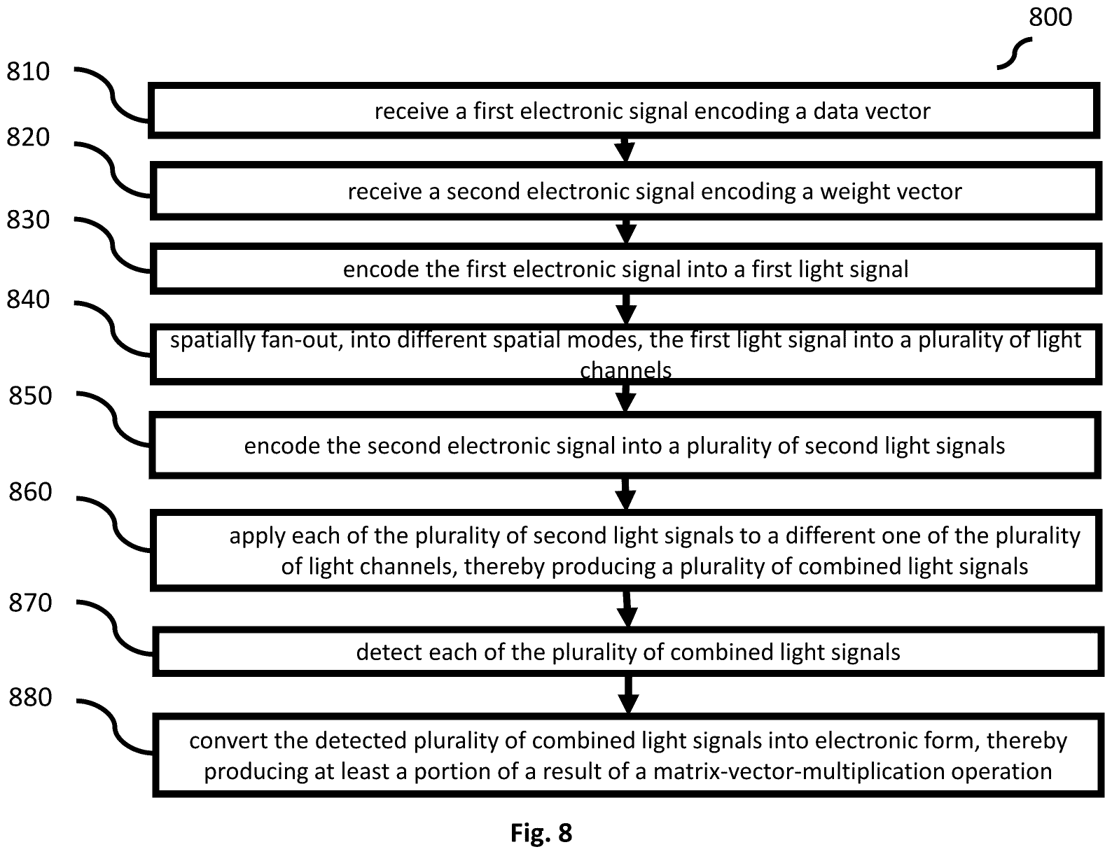

FIG. 8 is a flow diagram of example process 800 for performing a matrix-vector-multiplication operation for artificial neural network processing. Process 800 may be performed, by way of example, by a photonic MVM processor, such as the one shown and described in relation to FIG. 1. While the operations of process 800 are described in a particular order, it should be understood that the order may be modified and operations may be performed in parallel. Moreover, it should be understood that operations may be added or omitted.

At 810, a first electronic signal encoding a data vector may be received. At 820, a second electronic signal encoding a weight vector may be received. At 830, the first electronic signal may be encoded into a first light signal. At 840, the first light signal may be spatially fanned-out, into different spatial modes and into a plurality of light channels. At 850, the second electronic signal may be encoded into a plurality of second light signals. At 860, each of the plurality of second light signals may be applied to a different one of the plurality of light channels, thereby producing a plurality of combined light signals. At 870, each of the plurality of combined light signals may be detected. At 880, the detected plurality of combined light signals may be converted into electronic form, thereby producing at least a portion of a result of a matrix-vector-multiplication operation. The encoding the first electronic signal may include modulating the first electronic signal using amplitude modulation. The encoding the second electronic signal may include modulating the second electronic signal using amplitude modulation. The plurality of combined light signals may be summed.

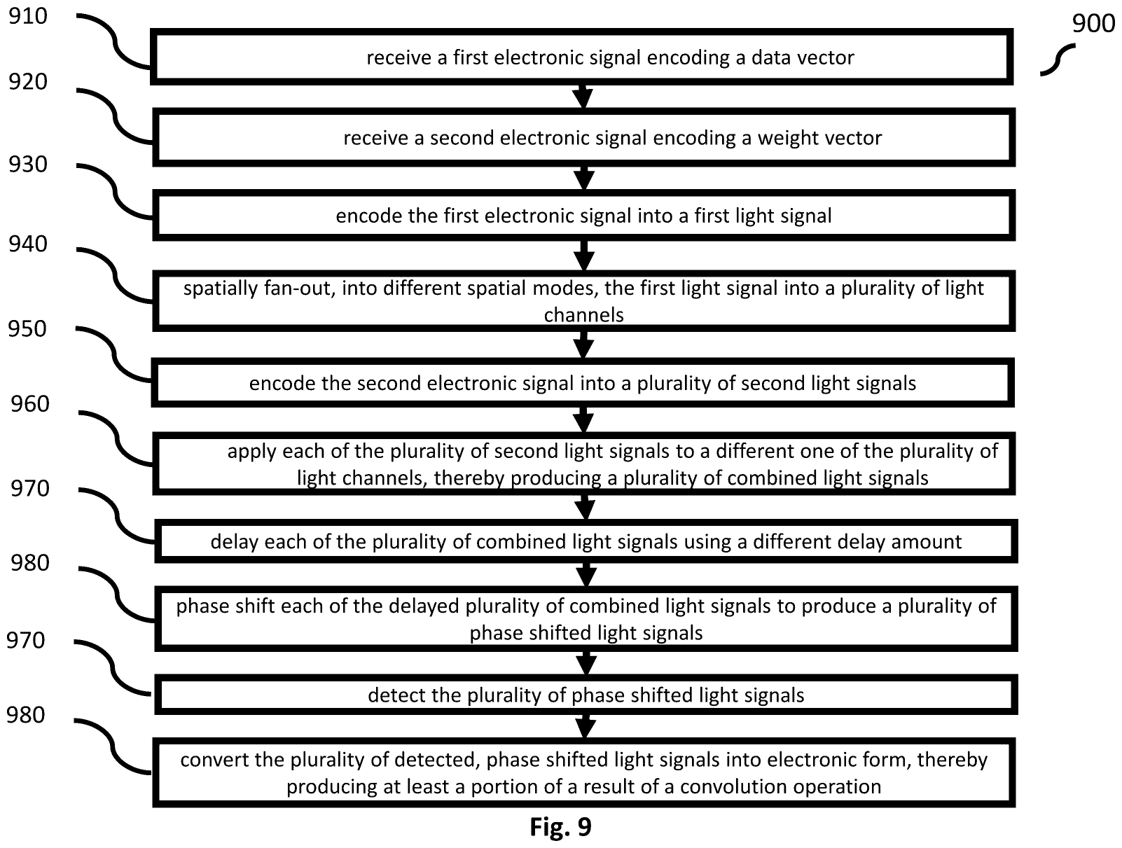

FIG. 9 is a flow diagram of example process 900 for performing a convolution operation for artificial neural network processing. Process 900 may be performed, by way of example, by a convolution accelerator, such as the one shown and described in relation to FIG. 6. While the operations of process 900 are described in a particular order, it should be understood that the order may be modified and operations may be performed in parallel. Moreover, it should be understood that operations may be added or omitted.

At 910, a first electronic signal encoding a data vector may be received. At 920, a second electronic signal encoding a weight vector may be received. At 930, the first electronic signal may be encoded into a first light signal. At 940, the first light signal may be spatially fanned-out into different spatial modes and into a plurality of light channels. At 950, the second electronic signal may be encoded into a plurality of second light signals. At 960, each of the plurality of second light signals may be applied to a different one of the plurality of light channels, thereby producing a plurality of combined light signals. At 970, each of the plurality of combined light signals may be delayed using a different delay amount. At 980, each of the delayed plurality of combined light signals may be phase shifted to produce a plurality of phase shifted light signals. At 990, the plurality of phase shifted light signals may be detected. At 995, the plurality of detected, phase shifted light signals may be converted into electronic form, thereby producing at least a portion of a result of a convolution operation. The encoding the first electronic signal may include modulating the first electronic signal using amplitude modulation. The encoding the second electronic signal may include modulating the second electronic signal using amplitude modulation.

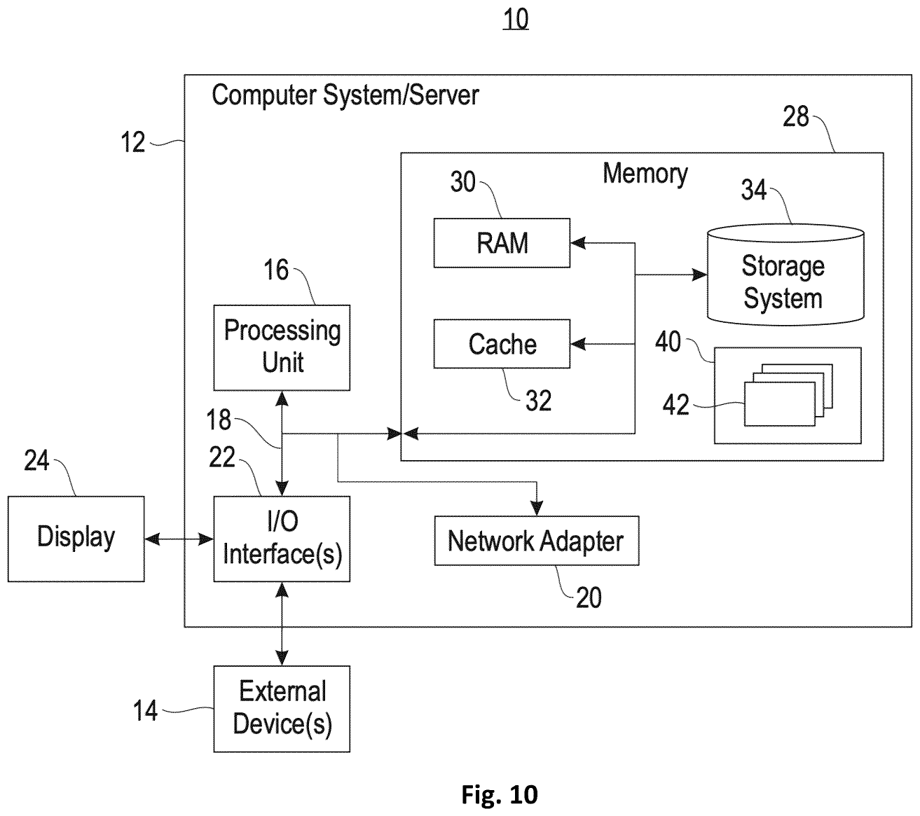

As shown in FIG. 10, computer system/server 12 in computing node 10 is shown in the form of a general-purpose computing device. For example, one or more computing nodes 10, with all, some, or multiple of the components shown in FIG. 1 and/or FIG. 6 and described herein, may be used as part of a cloud computing system. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, may be signals, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### EXEMPLIFICATION

The experiments described below with reference to the figures were conducted using devices and methods described herein.

The surge in artificial intelligence applications, encompassing machine vision, autonomous driving, remote sensing, and process simulation, relies on efficient and large-scale data processing. This may require highly scalable computation with high speed and low power consumption, calling for innovative solutions to overcome the limitations of electronic systems. Integrated photonics, as described herein, may play a pivotal role in addressing this challenge, leveraging the intrinsic properties of photons-natural parallelism, high bandwidth, and low latency. While alternative photonic computational approaches show promise, there may still be major limitations in terms of speed and power consumption when mapping the information from the electronic to optical domain (i.e., electro-optic conversion). Photonic computing accelerators utilizing a system-level thin-film lithium niobate circuit are described herein. Leveraging the strong electro-optic (Pockels) effect and propelling the scalability of thin-film lithium niobate, photonic matrix-vector-multiplication that support a speed up to 1.36 TOPS and energy consumption of 0.099 pJ/OP, simultaneously, are demonstrated. The system, described herein, features more than 300 thin-film lithium niobate functional components working synergistically, surpassing the current state-of-the-art thin-film lithium niobate photonics. Enabled by the integration, the circuit shows excellent stability when continuously processing over 20 hours, with computational error fluctuations limited to 0.04%. Further, binary-classification, digit classification, and image classification are demonstrated, showing the ability of the computing cores to execute real algorithms with remarkable computational accuracy. The results, described herein, underscore the promising potential of thin-film lithium niobate as a computational platform, addressing current bottlenecks in both electronic and photonic computation. Its unique properties of high-performance electro-optic matrix weight encoding and conversion, wafer-scale scalability, and compatibility with integrated lasers and detectors, position thin-film lithium niobate as a valuable complement to silicon photonics, with extensions to applications in ultrafast and power-efficient signal processing and ranging.

The desire for intelligent systems capable of autonomous learning, reasoning, and adaptation has fueled significant advancements in artificial intelligence (AI), transforming various application landscapes. As the demand for extensive computational resources continues to grow rapidly, traditional electronic computing approaches used to address AI needs are approaching their inherent limitations in speed and energy efficiency for parallel processing. This limitation has stimulated the exploration of novel accelerators with advanced computational paradigms. One example is photonic computing, which seeks to harness the unique properties of photons—high bandwidth enabled by high optical carrier frequency and inherent parallelism that leverages frequency and polarization degrees of freedom of photon—to perform computational tasks traditionally executed by electronic systems and unlock unprecedented speeds and energy efficiencies.

Driven by these unique advantages, as well as the rapid development of integrated photonics, photonic computing has emerged as a promising solution for advanced computing accelerators. Demonstrations using Mach-Zehner interferometer arrays, free space optics, silicon photonics with on-chip attenuator, photodetector, and ring banks, VCSELs with free space optics, as well as parallel processing of convolution neural networks with frequency multiplexing and phase change materials, showcase the versatility and potential of the photonics approach. However, a significant challenge still persists: low speed and/or high power consumption of the electro-optic (EO) conversion process used to map the stored electronic data into the optical domain. Yet, the EO conversion step may be inevitable, as the majority of data remains stored and processed in electronic form. Approaches utilizing variable attenuator or fast electro-optic modulators, typically implemented in silicon photonics or bulk system, may be capable of preparing the data at speeds ranging from kHz to GHz but may be associated with high-power consumption. At the same time, approaches employing static amplitude mask for data preparation, or those using spatial light modulators may be more energy efficient but limited by the slow speed of data preparation. Therefore, prior work may have demonstrated either high speed or low power consumption, but not both simultaneously. As a result, EO conversion may be a most critical hurdle for practical implementations of photonic computing in real-world applications. Ultimately, high-performance EO modulation may be necessary to achieve a high optical data rate that can match the low optical latency. However, a photonic accelerator that combines high-speed processing with low energy consumption, addressing the crucial challenge of EO conversion, may still be missing.

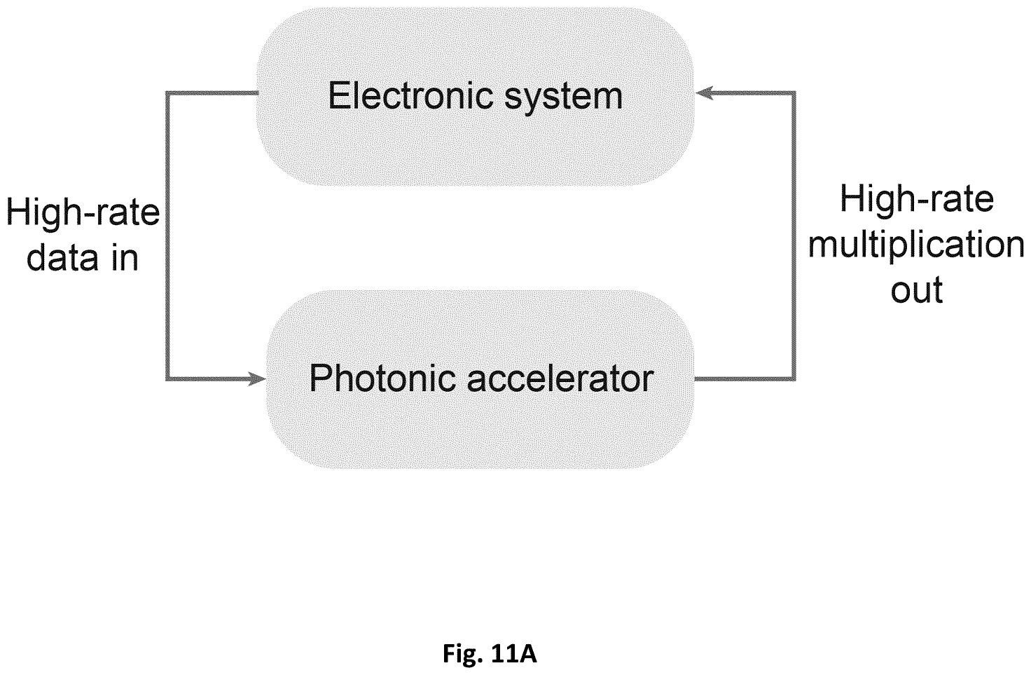

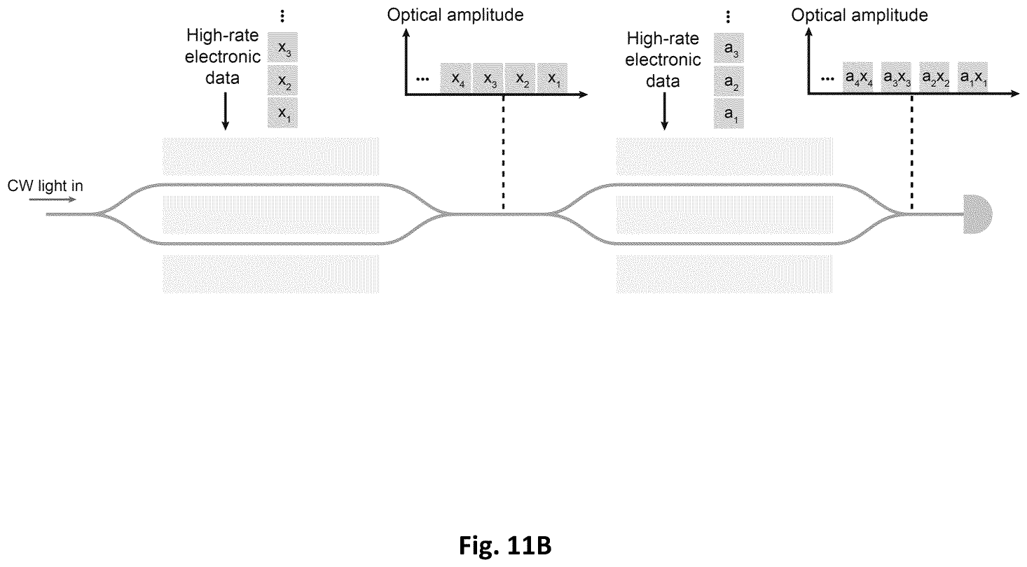

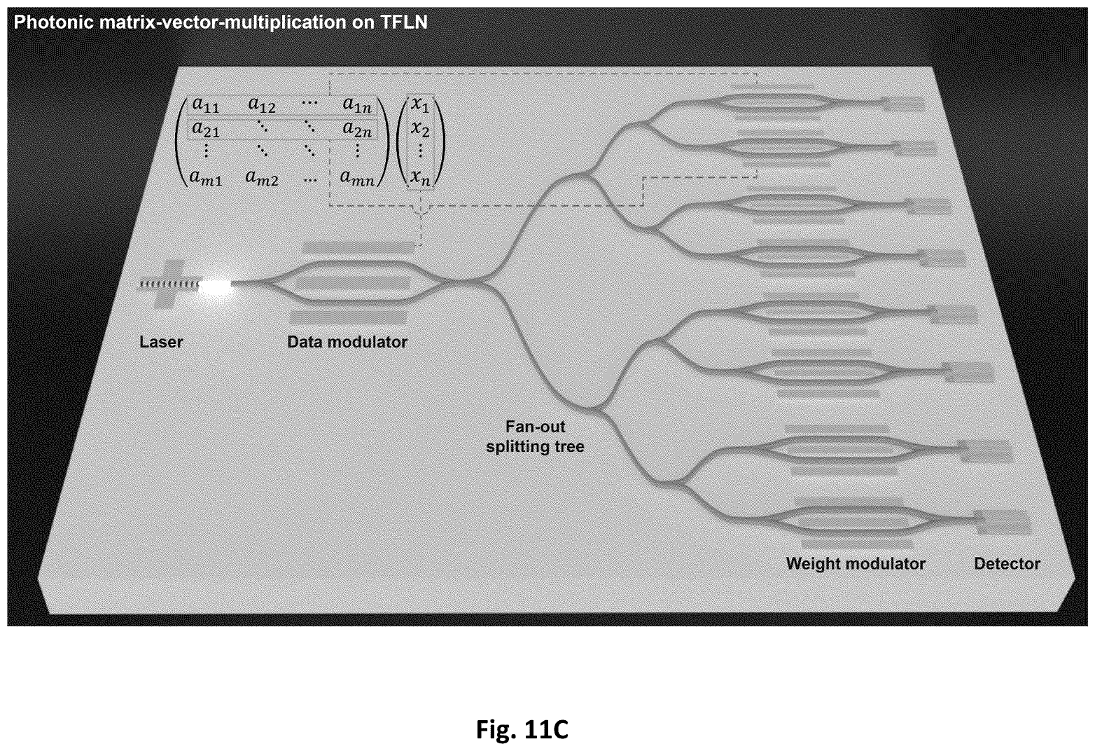

A high-speed and energy-efficient photonic matrix-vector-multiplication (MVM), using the Pockels EO effect in a thin-film lithium niobate (TFLN) circuit is demonstrated herein. Recent progress in TFLN photonic platform has enabled development of groundbreaking EO devices including modulators, frequency shifters, and comb generators, among others. The remarkable capabilities of these devices may stem from the strong EO effect and may be facilitated by the tight confinement of both optical and electronic modes as well as low propagation loss. By seamlessly integrating these high-performance EO devices into an optimized large-scale photonic circuit, a scalable TFLN computing accelerator that addresses the current speed and power limitations of state-of-the-art computing architectures may be shown. The MVM accelerator, described herein, receives electronic data, may perform computations in the optical domain, and may return a result back to the electrical domain (FIG. 11A). The basic working principle may involve encoding two vectors to be multiplied electro-optically in the time domain, using two amplitude modulators in series (FIG. 11B and FIG. 11C). In the context of fully-connected deep neural networks (DNNs), where large-scale matrix-vector multiplication is paramount to data inference, an input data vector may be encoded into the amplitude of light by the first TFLN amplitude modulator. This light may be spatially fanned-out into distinct spatial channels, each representing a single vector-vector-multiplication in the DNN. A machine-learned weight vector may be subsequently mapped onto the optical signal using the second TFLN amplitude modulator. The intensity of light passing through both modulator may thus be proportional to the product of the signals brought to each modulator, resulting in multiplication of the weight vector with the data vector. The light may then be detected using a photodetector and summed electronically, converting the result back into the electrical domain.

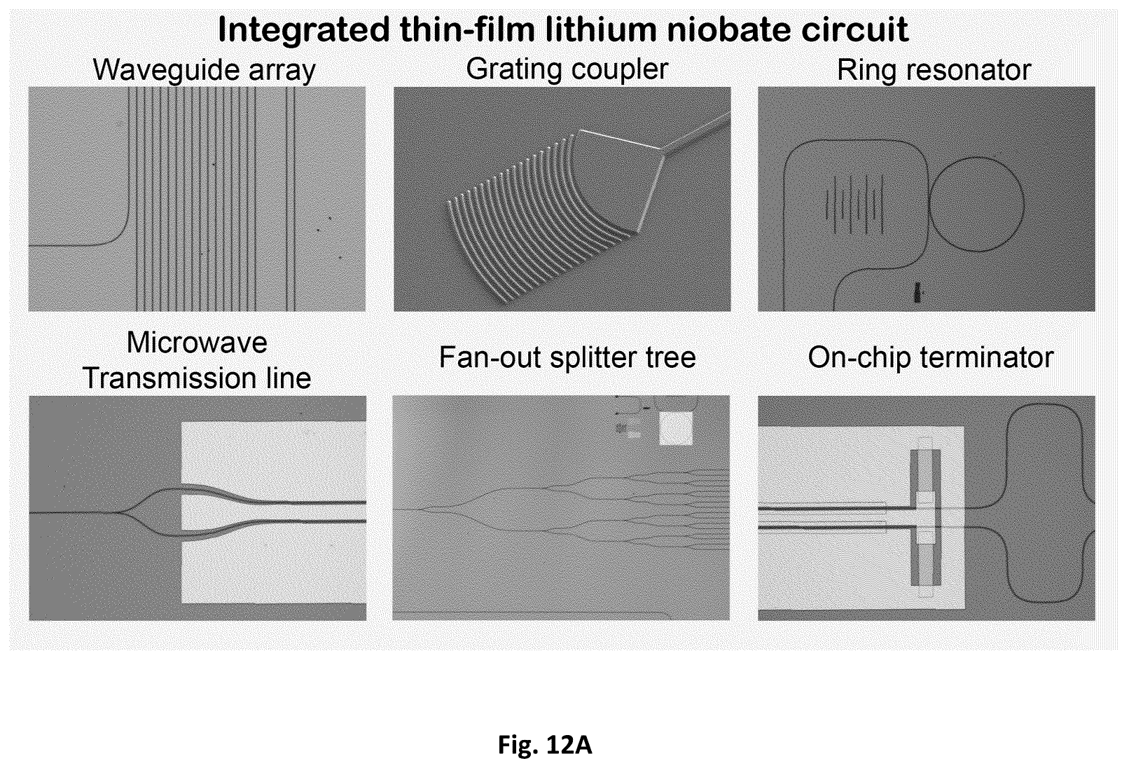

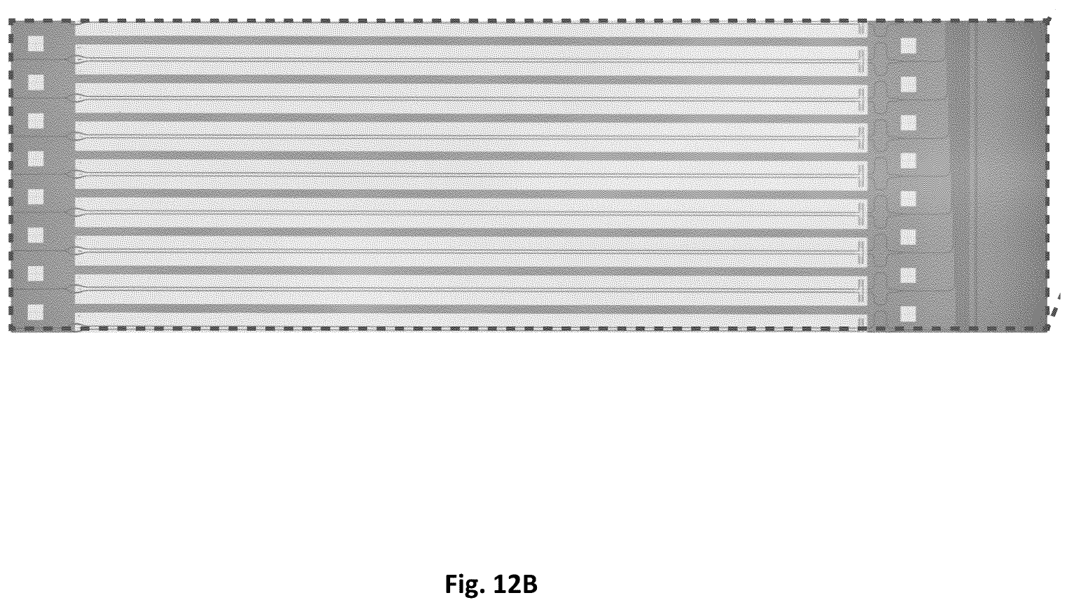

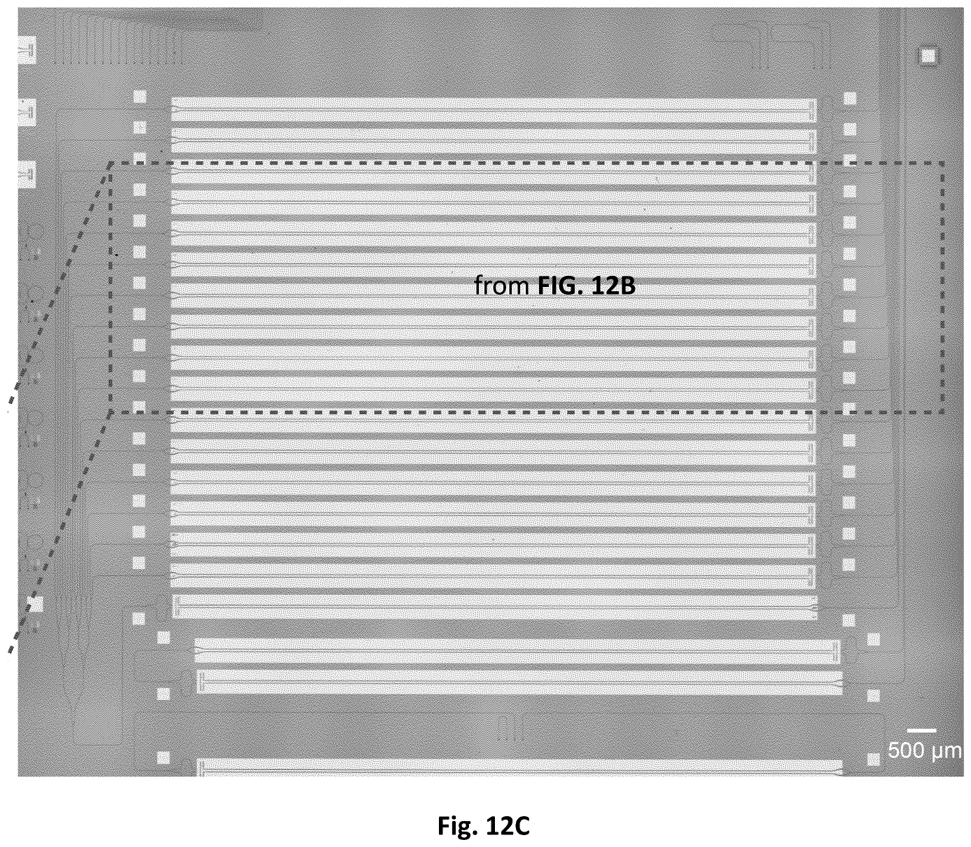

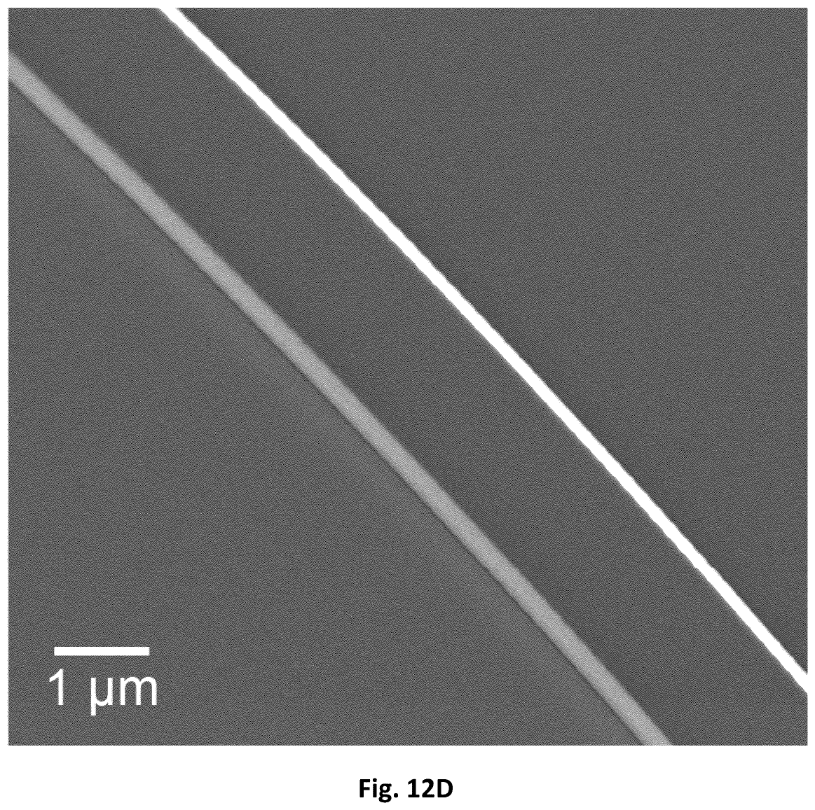

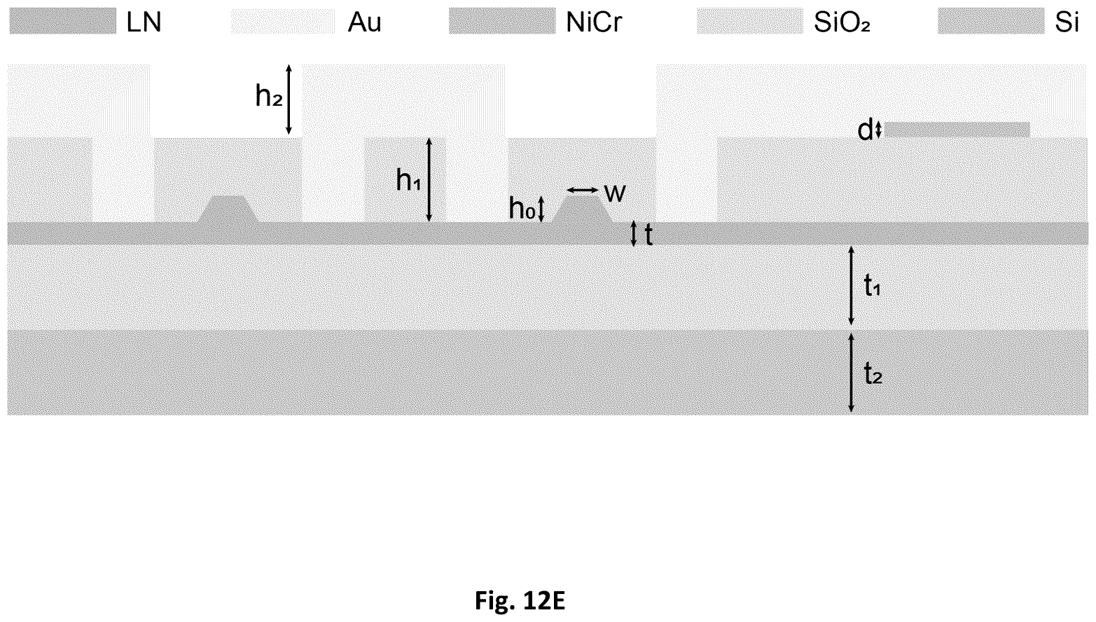

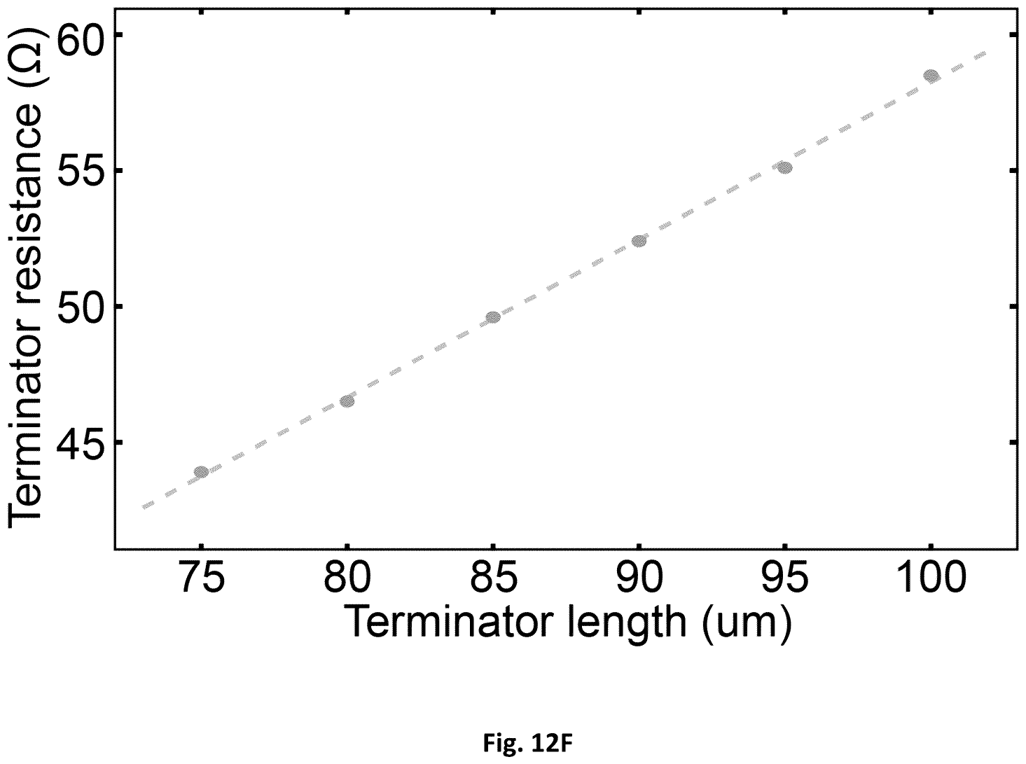

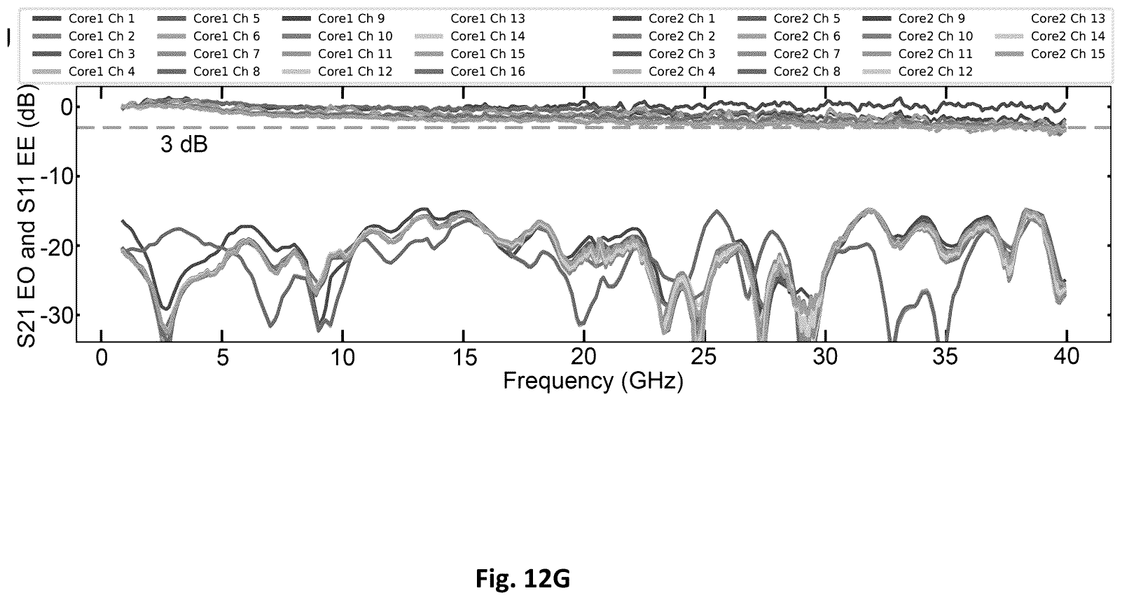

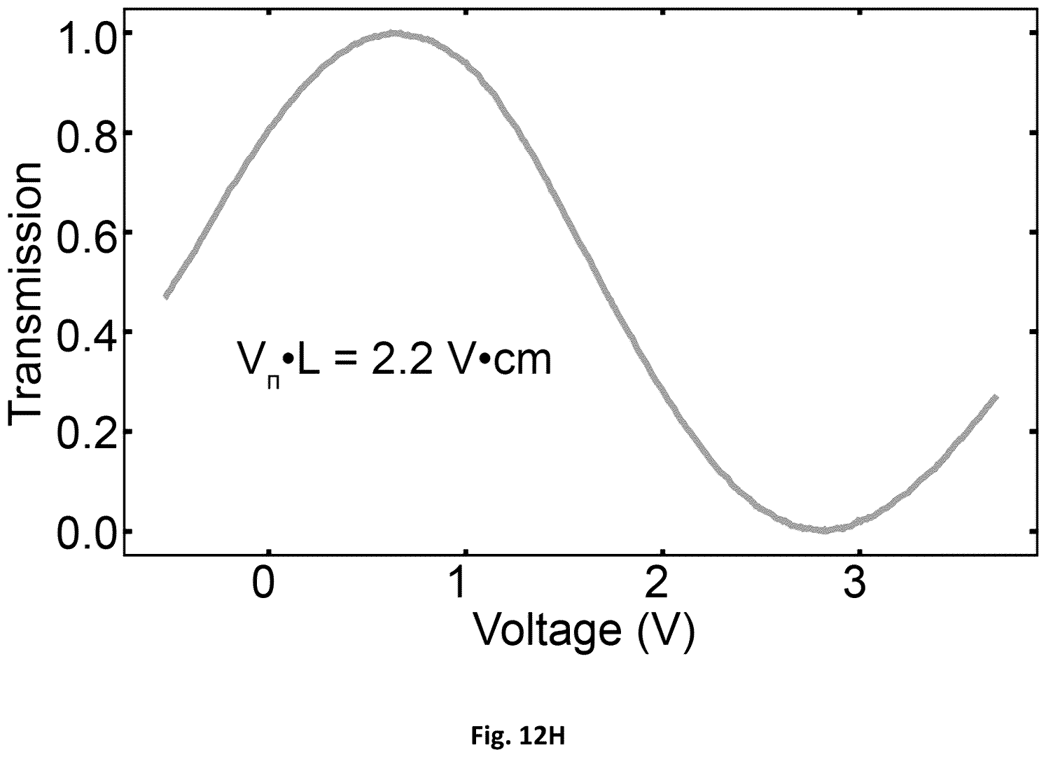

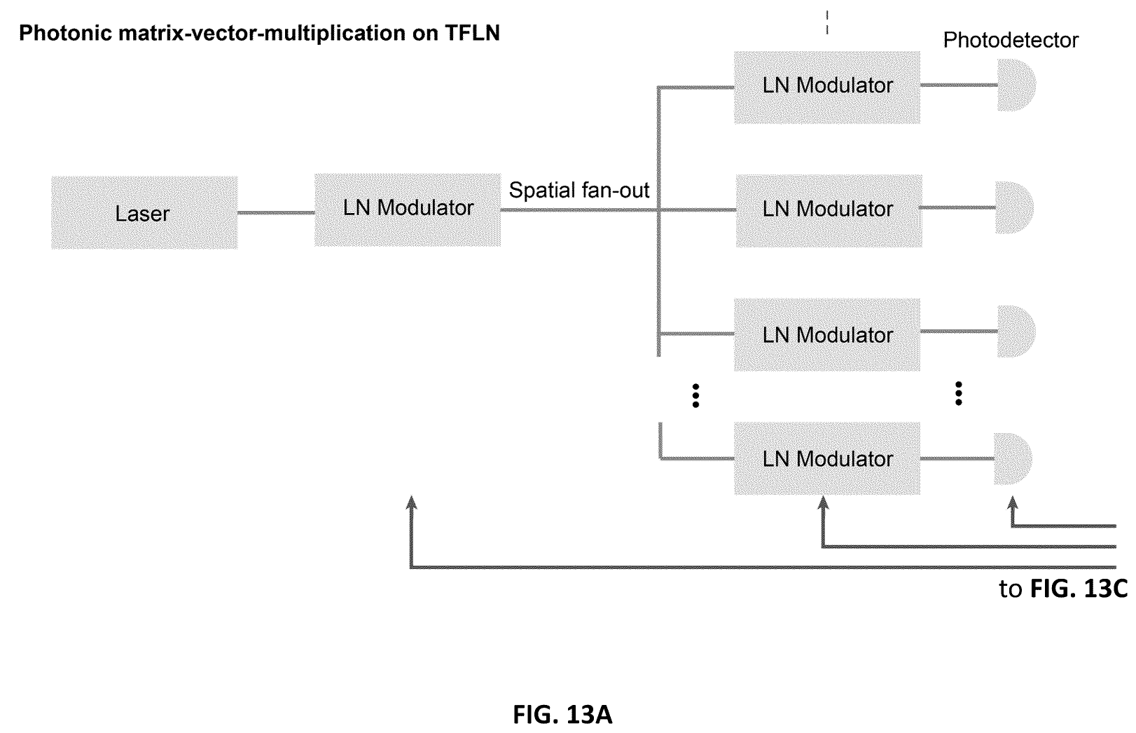

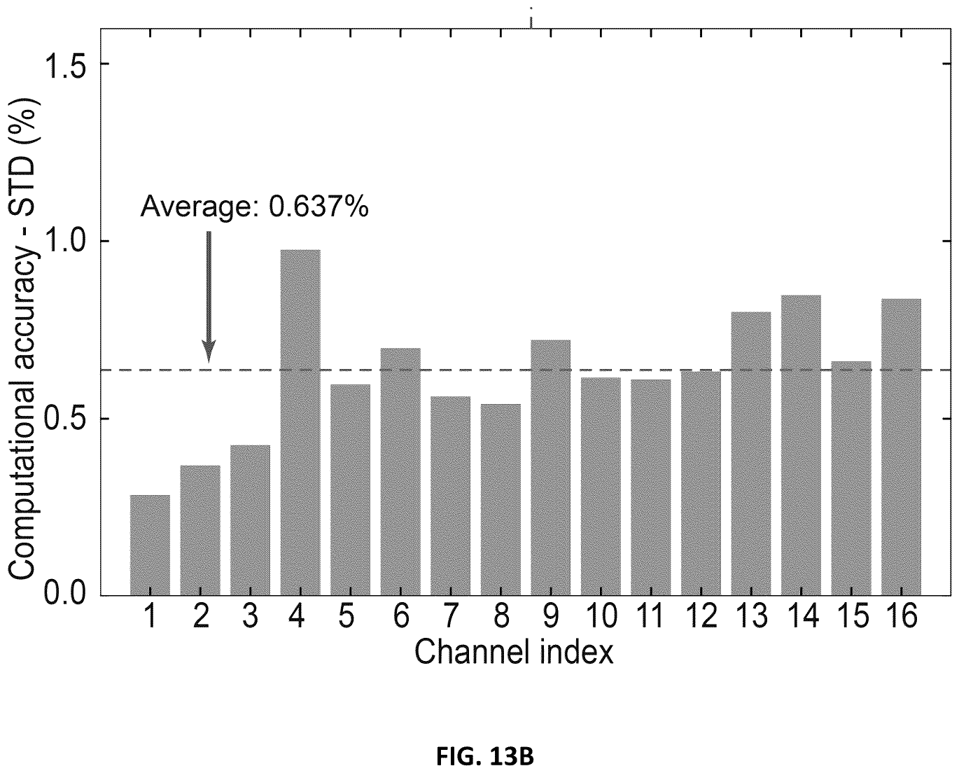

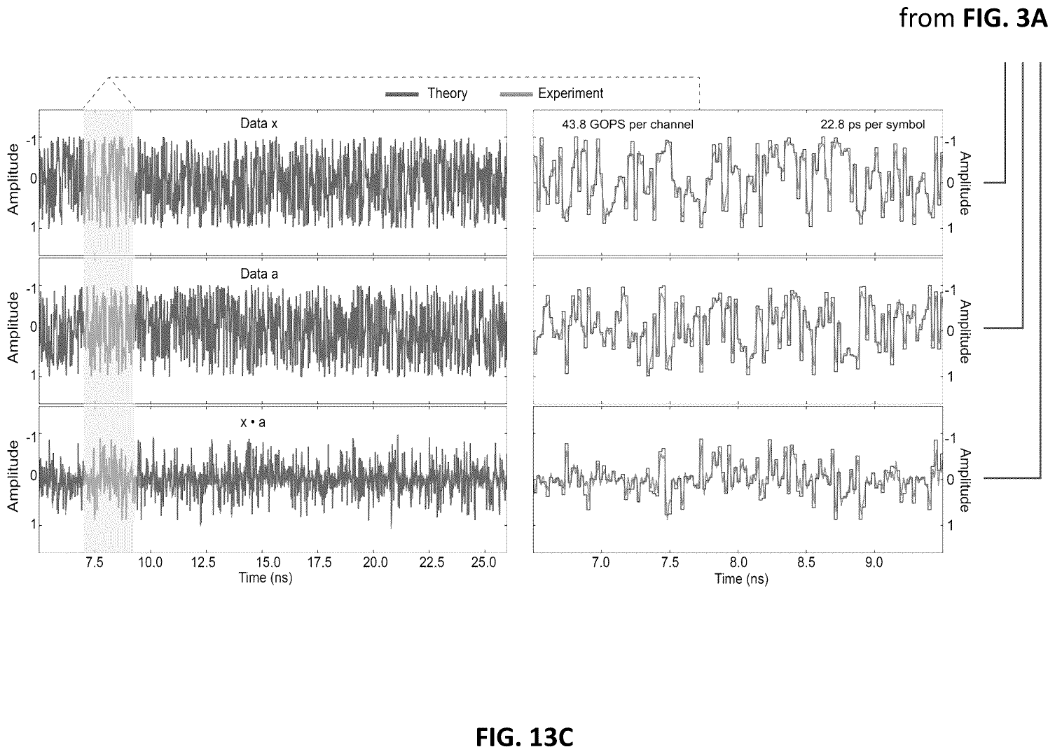

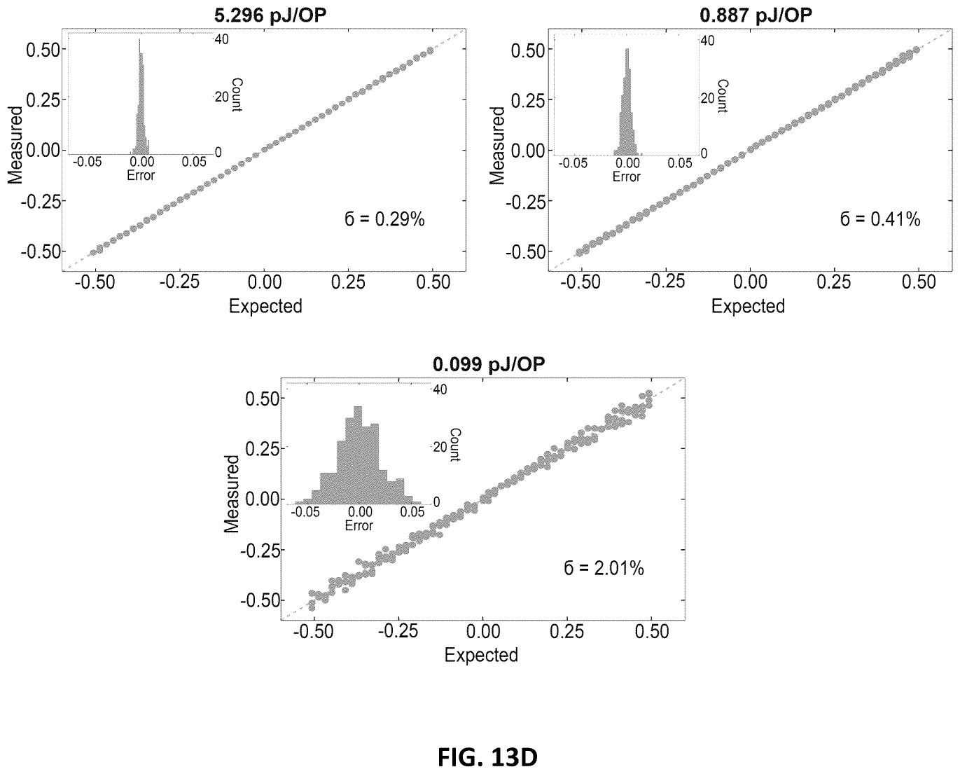

To demonstrate the proposed integrated computing core, individual components were developed and combined them into a TFLN photonic circuit on a single chip. The accelerator contained M=2 computing cores each with N=16 channels, realized by a spatial fan-out. It was noted that one of the channels was broken, and thus the accelerator performed total of M×N−1=31 multiplications in parallel. Each of the two computing cores contained more than 150 TFLN components, including 49 Y-splitters, 34 waveguides for push-pull modulation, 33 waveguides for routing and connections, 17 on-chip terminators, 17 microwave transmission lines, and 17 grating couplers (see FIG. 12A-FIG. 12C and section “Design principles of various components” below for further details). The waveguides were fabricated by high-quality direct dry etch on thin-film lithium niobate. The smooth sidewall achieved over the entire circuit led to a low propagation optical loss of 0.28 dB/cm, achieved by optimizing the reactive ion etching process (FIG. 12D and see “Design principles of various components” below). This low propagation loss was paramount for achieving large-scale TFLN circuit as well as energy-efficient computing. It enabled a one-to-sixteen fan-out splitter tree with added insertion loss of 0.135 dB per channel (see “Design principles of various components” below). The microwave circuit for modulation was accomplished using two layers of gold (labeled with h₁ and h₂ in FIG. 12E) with nickel-chromium (NiCr) resistors (FIG. 2E). The bottom layer of gold was required for efficient modulation and direct-current (DC) tunability, while the top layer interfaced with resistors. The utilization of NiCr ensured high-resistance terminators with high-power handling and minimal feature size (FIG. 12F). Each 1-cm long modulator featured >40 GHz bandwidth (limited by the 40-GHz detector used), >20 dB microwave reflection suppression, V_{π}·L˜2.2 V·cm, and >20 dB extinction ratio (FIG. 12G and FIG. 12H). Using this circuit, a high-speed photonic MVM operation with low power consumption was first demonstrated (FIG. 13A). Random vectors of length 1,000 were generated as data and weight vectors. Both vectors were encoded into the time domain with a speed v=43.8 GOPS per channel and multiplied after light passed through the data and weight vectors. The results were in excellent agreement with theory (FIG. 13C and see “Matrix-vector-multiplications: experimental scheme and concept” and “Matrix-vector-multiplications: experimental details” below). Due to limitations of available electronics (namely number of high-speed channels on the AWG), the circuit performance was evaluated by driving each channel separately. Then, total computational speed of the chip was inferred as (M×N−1)×v=1.36 TOPS. It was noted that driving all channels simultaneously could be achieved by co-packaging the photonic chip with high-speed electronic circuits, which may not be a fundamental limitation since TFLN EO modulators can achieve CMOS-compatible voltages. Operating at such a high speed (43.8 GOPS per channel), the energy consumption was evaluated while simultaneously assessing computational accuracy under varying optical power conditions. The experiments described herein revealed a minimal energy consumption of 0.099 pJ/OP, demonstrating robust computational accuracy with high energy efficiency for the entire photonic system (see “Computational accuracy” below for details). This assessment included required input optical power from the laser, microwave power on modulators, as well as energy consumption on detectors, with limitations imposed by the noise floor of the output signal (see “System characterization: speed and energy consumption calculations” below for details. Note: The power consumed by AWG, electronic computer, etc. were note included). This indicated the high efficiency and speed of TFLN photonic computing system.

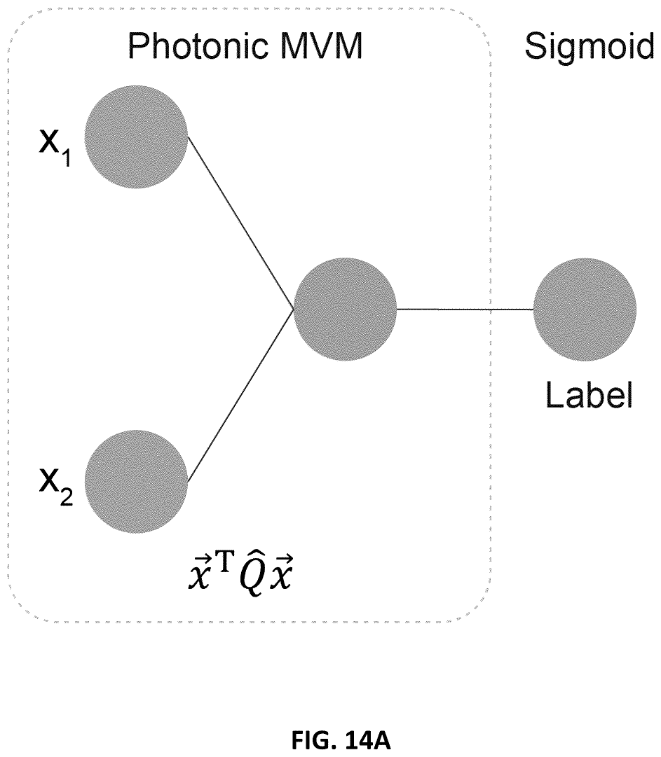

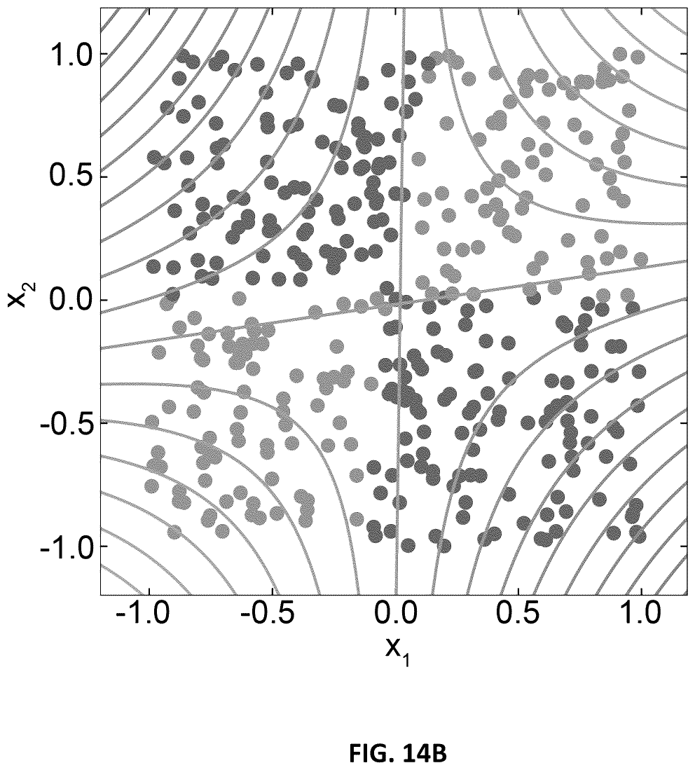

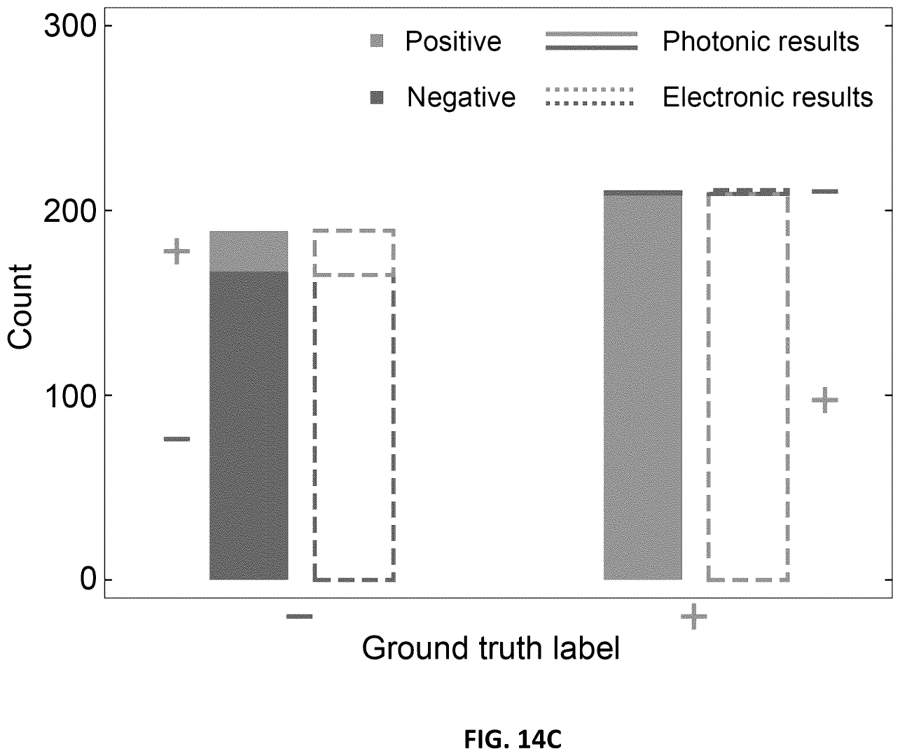

A single channel of the TFLN accelerator was utilized to demonstrate real computational algorithms. The accelerator was first used for a binary classification problem (see FIG. 14), specifically, the exclusive or (XOR) problem over points in a two-dimensional plane. The data point

$$\vec{x} = ( \begin{matrix}{x}_{1} \\ {x}_{2}\end{matrix} )$$

was input into the circuit and a linear transformation was applied, followed by a nonlinear activation using an electronic computer to obtain the label. The sign of the label indicated the category of the data point (FIG. 14A). A total of 400 data points were tested, with the classification results shown in the 2D plane (FIG. 14B), achieving an overall accuracy of 93.8% (93.5% on the electronic computer). Further analysis histograms of accuracy of classification results revealed an accuracy of 98.6% (99.1% on the electronic computer) for data points with positive ground truth and 88.4% (87.3% on the electronic computer) for data points with negative ground truth (FIG. 14C). This evaluation demonstrated the effectiveness of the photonic computing core for performing binary classification tasks, showcasing competitive accuracy compared to traditional electronic computers.

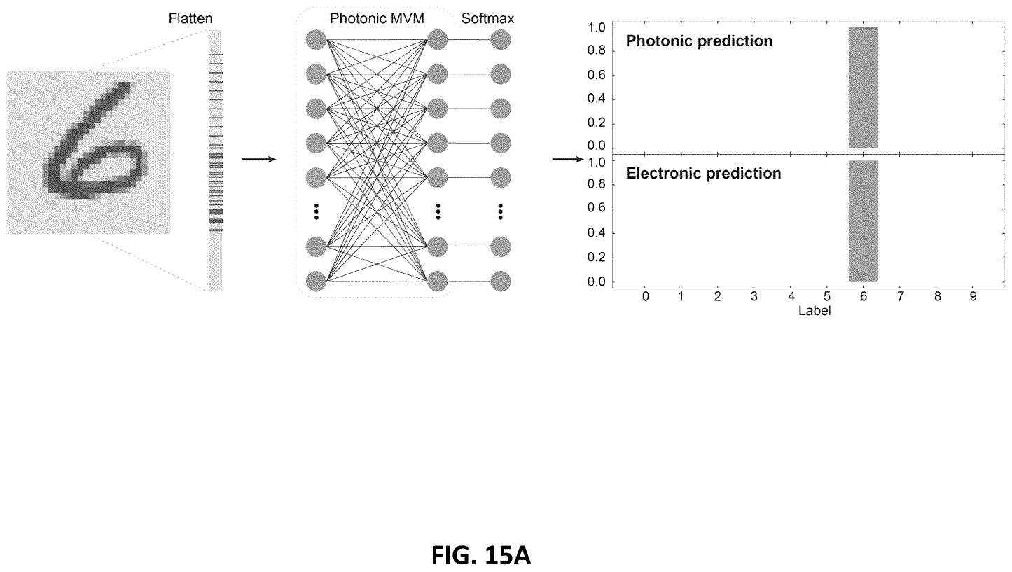

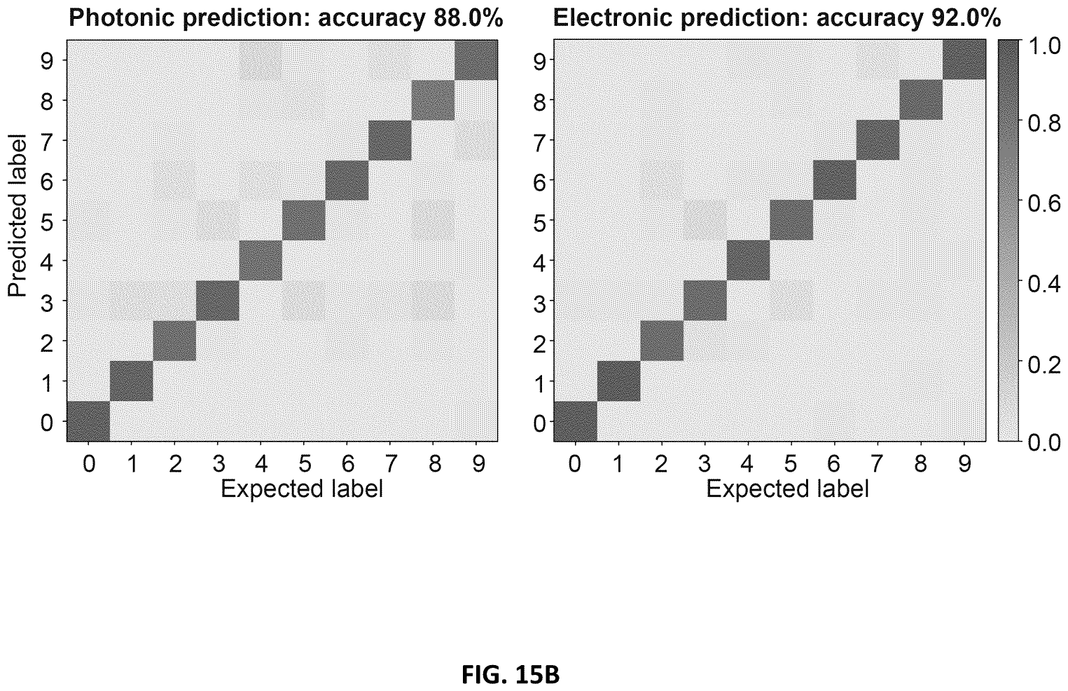

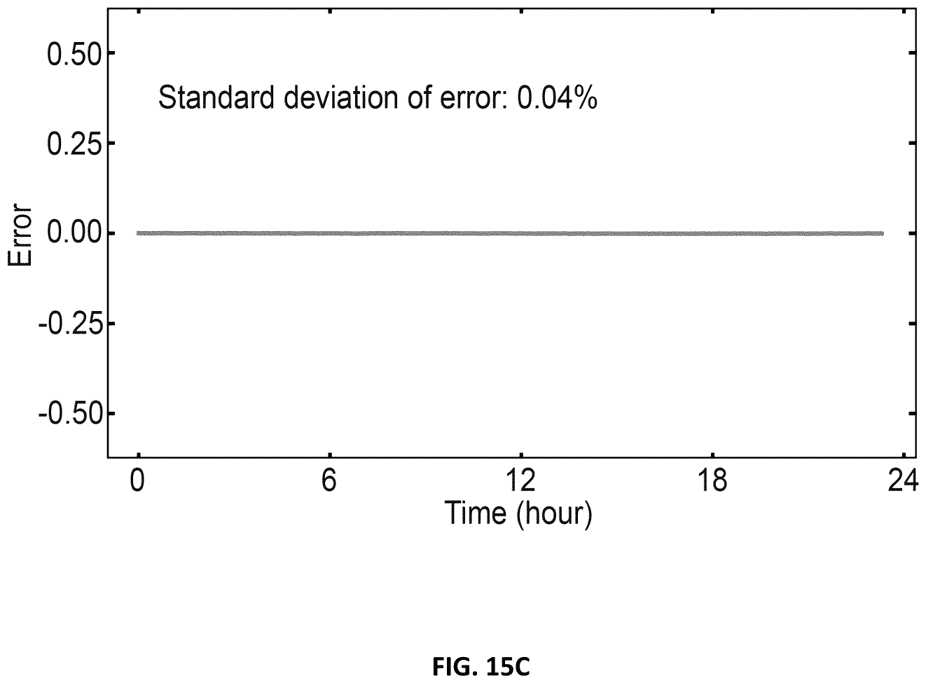

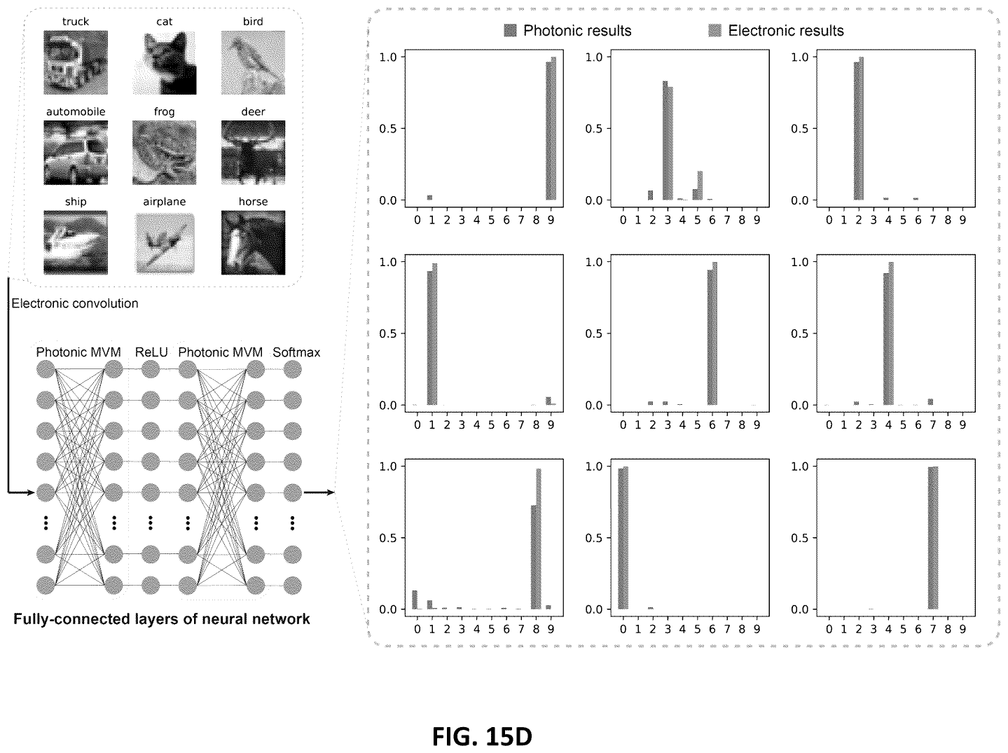

Next, the photonic accelerator was applied to a handwritten digit classification problem. A two-layer model was chosen to perform the classification (FIG. 15A), with an input vector with size 784 encoded in time for layer 1, and 10 neurons for layer 2, respectively. Modified National Institute of Standards and Technology (MNIST) images were input into the processor and underwent 10 vector-vector multiplications followed by electronic Softmax activation. The confusion matrices (FIG. 15B) generated over 500 test images indicated that the circuit can efficiently perform MVM operations for inference, using a neural network algorithm. The results demonstrated a total accuracy of 88% (92% using the electronic computer). Together with binary classification, the results showcased the versatility of the photonic computing system in handling different models including neural network tasks with vectors of arbitrary length. Importantly, the stability of the system was evaluated by running the same MVM task on the accelerator for over 20 hours. Excellent system stability was observed with a standard deviation of error fluctuation of 0.04% (FIG. 15C and see “Long term stability” below for details).

Finally, to assess the practical utility of the computing system in solving real-world problems with multi-layers deep neural networks, the demonstration was extended to image classification using images taken from the CIFAR-10 database. The images underwent initial processing with a convolution layer using an electronic computer, a step that, in principle, may also be implemented on TFLN by customizing the circuit for convolution operations rather than MVM. In the setup, the circuit was used to perform the fully connected layers of the convolutional neural network (CNN). The input vector had a size of 1012 as the first layer encoded in time and an intermediate layer of 128 neurons was used before the final output layer with 10 neurons, respectively. Images in 10 different categories were tested, with examples including trucks, cats, birds, automobiles, frogs, deer, ships, airplanes, and horses presented, with excellent classification results (FIG. 15D). This confirmed its potential for complex image recognition and analysis, since the correct classification of one image required a significant amount of MVM operations. (Experimental details of all algorithms for FIG. 14 and FIG. 15 may be found in “Computational accuracy” and “Machine learning model” below). The work described herein presents a photonic matrix-vector-multiplication accelerator on thin-film lithium niobate, capable of performing increasingly complex algorithmic tasks, from binary classification, MNIST digit classification, to actual image classification. Different from task-specific accelerators, used for e.g. convolution or vision-based tasks, the MVM accelerator described herein may be well suited for general computing tasks. The demonstration was enabled by a large scale system-level TFLN circuit, a first of its kind, consisting of more than 300 components.

Leveraging the TFLN platform, the simultaneous achievement of high speed and low power consumption in photonic computing was demonstrated for the first time, with a performance comparable to the state-of-the-art electronics. This was achieved by increasing the scale of TFLN integration while maintaining the high performance of individual devices. Future improvements to enhance the performance metrics to match or exceed state-of-the-art may be straightforward: reducing the half-wave voltage (Vpi) to 1V, increasing the bandwidth to 100 GHz, and minimizing the optical propagation loss of waveguides to 0.03 dB/cm, each of which has been demonstrated in TFLN devices. It is worth noting that transitioning the accelerator to visible wavelengths may further reduce power consumption with sub-volt TFLN modulators. Integrating the computing core with on-chip lasers and detectors may offer another avenue for efficiency improvements by significantly reducing coupling loss from fiber to chip, potentially lowering energy consumption by at least one order of magnitude. Altogether, it may be possible to further increase the speed and reduce energy consumption to 140 TOPS with 200 GOPS per channel and 0.83 fJ/OP (see “System characterization: speed and energy consumption calculations” below for details).

It is worth noting that the approach, presented herein, to address the EO conversion challenge may be compatible with other photonic accelerators. Thus, this work may enable novel hybrid approaches (e.g. combining TFLN EO conversion with free space optics for computation) that require ultrahigh bandwidth modulation for data encoding. TFLN may e an ideal platform for this task, owing to exceptional performance of EO conversion, thus offering the potential to overcome existing speed and power bottlenecks in computation. The full power of the TFLN-based photonic accelerator may be unlocked by integration with high-speed electronic circuits, including multi-channel DAC, ADC, and FPGA. It is believed that TFLN-based photonic computing may hold great promise for applications in vision, sensing, ranging, and even quantum computing, and the present work may stimulate further exploration of this exciting platform.

FIGS. 11A-11C depict a photonic matrix-vector-multiplication (MVM) accelerator on thin-film lithium niobate according to various embodiments of the present disclosure. FIG. 11A depicts the concept of photonic accelerators. Data inside the electronic system (e.g. a computer) may be sent into the accelerator with high rates and converted to the optical domain. Computation may be performed in the accelerator and it may return the multiplication back into the electronic system. FIG. 11B shows an illustration of the basic working principle of the photonic accelerator. The light may first pass through an initial amplitude modulator (AM) which encodes the data vector \vec{x} onto the light's amplitude. This light may then travel through a second AM, which, when driven in time-synchrony with the data-encoded light stream, may apply another vector \vec{x} and may achieve a total amplitude encoding corresponding to the independent components contributing to \vec{x}·\vec{a}. Finally, this light may be detected by a low-noise, high-speed photodetector. The photocurrent amplitude may track the patterned amplitude fluctuations of the impinging light up to its detection bandwidth, and the components contributing to \vec{x}·\vec{a} may be directly read-off by an oscilloscope. The electronic summation of the components may yield \vec{x}·\vec{a}. FIG. 11C shows an illustration of the system, including the laser, detector, and TFLN modulator for EO conversion and multiplication. The MVM accelerator may receive the vector data as well as the matrix weights from the computer. The vector data may first be encoded in the time domain of the optical field through an amplitude modulator and then may fan-out into N different spatial channels (N=8 in this figure for illustration) to implement parallel multiplication via spatial multiplexing. For each channel, another amplitude modulator may be applied to multiply the weights to the input vector. Finally, detectors may convert the multiplication results back into electronic signals. As described herein, the accelerator may have M cores with each core having N channels (M=2, N=16).

FIGS. 12A-12H depict an integrated thin-film lithium lithium niobate photonic circuit according to various embodiments of the present disclosure. FIG. 12A shows optical microscope or scanning electron microscope images of building blocks used in the integrated TFLN circuit: waveguide array (top left) for routing, connecting, and modulation; grating coupler (top center) for efficient in- and out-coupling of light; ring resonator (top right) for evaluating the propagation loss and etch quality; microwave transmission line (bottom left) for delivering efficient modulation; fan-out splitter tree (bottom center) for large-scale optical energy distribution into distinct spatial channels; on-chip terminator (bottom right) for high-quality microwave impedance matching. FIG. 12B shows optical microscope images of 7 weight modulator array in the TFLN accelerator. FIG. 12C shows a full image of one computing core. (the circuit contains two computing cores on the same chip). FIG. 12D shows a scanning electron microscope image of a high-quality waveguide with low propagation loss, enabling low energy consumption for the whole circuit. FIG. 12E shows a cross-section illustration of the TFLN circuit, including gold, nickel-chromium (NiCr), lithium niobate, silicon dioxide, and silicon. d=100 nm, w=1.5 μm, h₀=300 nm, h₁=800 nm, h₂=800 nm, t=300 nm, t₁=4.7 μm, t₂=500 μm. FIG. 12F shows a measured terminator impedance vs. resistor length. FIG. 12G shows S₂₁ EO and S₁₁ EE response of weight modulators in the circuit. In this example, Core1 has 16 weight modulators and core2 has 15 weight modulators (fabricated 16 with 1 modulator not working). In this example, all modulators have a bandwidth beyond 40 GHz (measurement limited by the detector bandwidth (40 GHZ)). FIG. 12H shows V_{π}·L of modulators in the circuit. The modulator lengths are 1 cm.

FIGS. 13A-13D depict high-speed and energy-efficient photonic matrix-vector-multiplications on thin film niobate according to various embodiments of the present disclosure. FIG. 13A shows a two-dimensional illustration of the structure of a photonic MVM computing core. FIG. 13B shows computational accuracy for different channels in one computing core. The differences in accuracy between different channels may be mainly due to the unoptimized operation parameters in each path, which, while not limiting the ability to perform algorithms, can be further improved by fine tuning the system. FIG. 13C shows an example waveform of an MVM operation for two random vectors \vec{x} and \vec{a} with 22.8 ps/symbol. FIG. 13D shows the computational accuracy for the MVM operation vs. different energy consumption by varying the optical power, showing a lowest energy consumption of 0.099 pJ/OP at 22.8 ps/symbol, with excellent computational accuracies. The inset gives error of the computation (Error=Measured−Expected). The σ is the standard deviation of the error.

FIGS. 14A-14C depict photonic binary classification according to various embodiments of the present disclosure. FIG. 14A shows an illustration of the binary classification model (XOR) for two-dimensional vector \vec{x}=[x₁, x₂]^{T}. FIG. 14B shows classification results on 400 randomly selected two-dimensional vectors in the problem space. FIG. 14C shows a comparison between photonic and electronic classification results over the 400-vector test set. The photonic circuit (electronic computer) provides a classification accuracy of 93.8% (93.5%).

FIGS. 15A-15D depict matrix-vector-multiplications for fully-connected layers of photonic neural networks according to various embodiments of the present disclosure. FIG. 15A shows image classifications for an MNIST handwritten digit. The image was flattened into a single vector encoded in the time domain. An example image (number six) is shown on the left. A two-layer photonic neural network was used to perform the classification tasks (center). The output of the photonic MVM was then sent back to the computer to perform a nonlinear activation (right). The final classification results agreed well with the electronically computed result. FIG. 15B shows statistics of MNIST handwritten digit recognition. 500 MNIST images were processed, and the confusion matrices show excellent photonic results with an accuracy of 88% (92% using pure electronic computer). FIG. 15C shows MVM stability. The computing core was set for continuously running over 20 hours with fluctuation of 0.04%. FIG. 15D shows real image classification. Real images were extracted from the CIFAR-10 database and classified using a convolutional neural network. The images were first electronically processed through convolution layers, flattened into vectors, and then sent into the device to be classified using the fully-connected neural network (bottom left). 9 example figures of a truck, cat, bird, automobile, frog, deer, ship, airplane, and horse (top left) together with the classification results are shown (right), indicating the photonic MVM processors can perform computations over real images.

### Device Fabrication

The devices in the study described herein were fabricated using a commercial X-cut lithium niobate (LN) on insulator wafer (NanoLN). This wafer comprised a 600 nm-thick LN layer, a 4.7 μm buried oxide layer (thermally grown), all mounted on a 525 μm-thick silicon (Si) handle. The fabrication process involved:

Patterning of optical layer: electron-beam lithography is used to define patterns on the optical layer of the device. This included rib waveguides and micro-ring resonators. Ar+− based reactive ion etching was then used to etch the optical layer down by 350 nm.

Defining bottom-layer electrode: microwave electrodes were defined using a combination of photolithography, electron-beam evaporation, and a bilayer lift-off process. Using this approach, an 800 nm-thick layer of gold (Au) was deposited to form the bottom layer of the microwave electrodes.

Cladding with SiO2: the devices were cladded with a 1.0 μm-thick layer of silicon dioxide (SiO2) using plasma-enhanced chemical vapor deposition (PECVD).

Depositing nickel-chromium resistor: the nickel-chromium (NiCr) layer was defined using photolithography with deposition through electron-beam evaporation, followed by a bi-layer lift-off process.

Defining top-layer electrode: a second layer of gold was deposited using a combination of photolithography, electron beam evaporation, and bi-layer lift-off. The thickness of the top layer gold was 800 nm.

The fabrication process resulted in a TFLN circuit with high-quality optical components and a well-defined microwave circuit to enable the high-performance matrix-vector-multiplication (MVM) operation on TFLN.

### Design Principles of Various Components

### Optical Waveguides and Ring Resonators

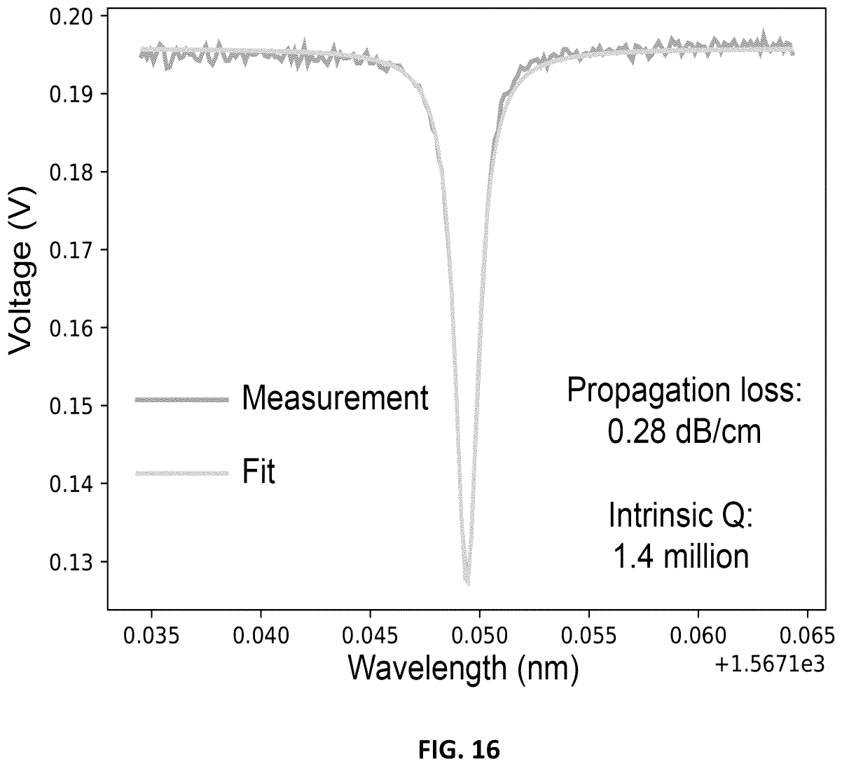

Optical waveguides may be the most basic component of the TFLN circuit. When designing the waveguide arrays, a pitch for adjacent waveguides was specifically designed to have negligible crosstalk and a bending radius with low bending loss. In this work, a pitch of 20 μm and a bending radius of 120 μm was used. The propagation loss was evaluated by measuring the quality factor of the ring resonator that was sitting close to the circuit on the same chip. A propagation loss of 0.28 dB/cm was extracted, which was consistent with the overall measured propagation loss of 3.485 dB (see section “System characterization: speed and energy consumption calculations”) FIG. 16 depicts propagation loss characterization, in accordance with various embodiments.

### Modulators

Electro-optic modulators may be central component of the photonic MVM accelerator to address the challenge of EO conversion. A Mach-Zehner interferometer structure was used to form an amplitude modulator, which included an input Y splitter for equal splitting of light into two paths, two waveguides for efficient phase modulation, and an output Y splitter for recombining the light from the two paths. To achieve high bandwidth, the microwave transmission line was designed close to 50Ω while maintaining sufficient center pin width to minimize ohmic losses. Different electrode gaps were characterized to test gate electrode separation to minimize V_{π}·L without inducing excess optical loss in the waveguide. The Y splitter was separately designed and tested, confirming equal power-splitting and negligible loss.

### On-Chip Terminators

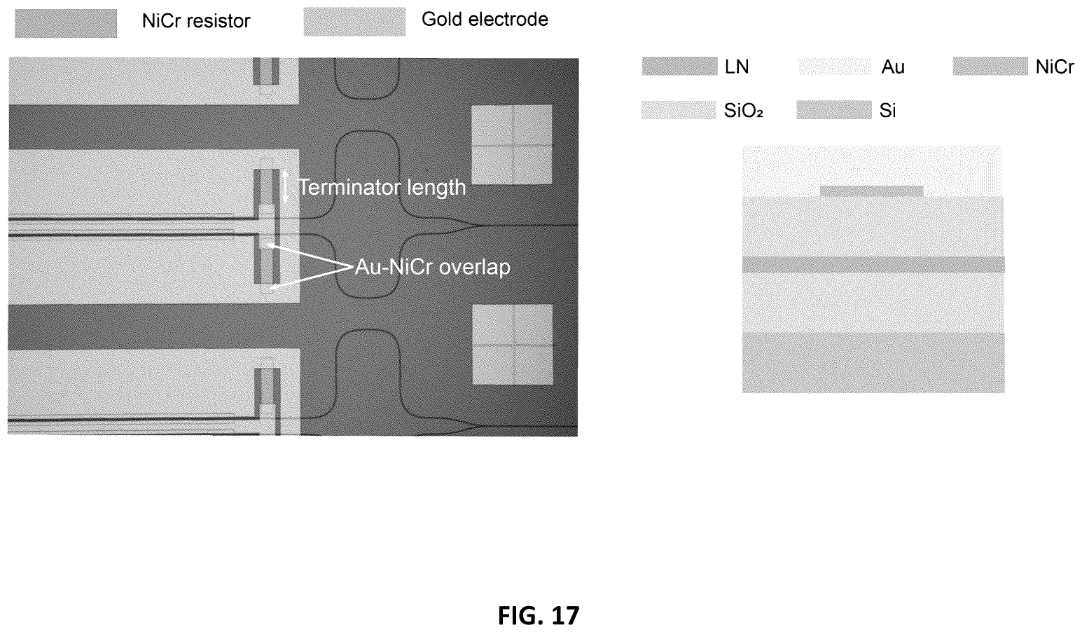

The terminator was designed to achieve a 50Ω termination for the co-planar waveguide microwave transmission line. NiCr was chosen due to its high resistivity. The film thickness of the NiCr was 100 nm. The waveguide avoided the NiCr region to ensure the flatness of the NiCr resistor on top of the oxide. A large overlap area between the gold and NiCr was used to ensure high power-handling ability of the resistor. FIG. 17 depicts on-chip terminator designs, in accordance with various embodiments. The overlap shown in FIG. 17 may ensure high power handling while the terminator length may be adjusted to obtain perfect impedance matching. An optical microscope image of the terminator region is shown on the left; a drawing of the cross section is shown on the right.

### Grating Couplers

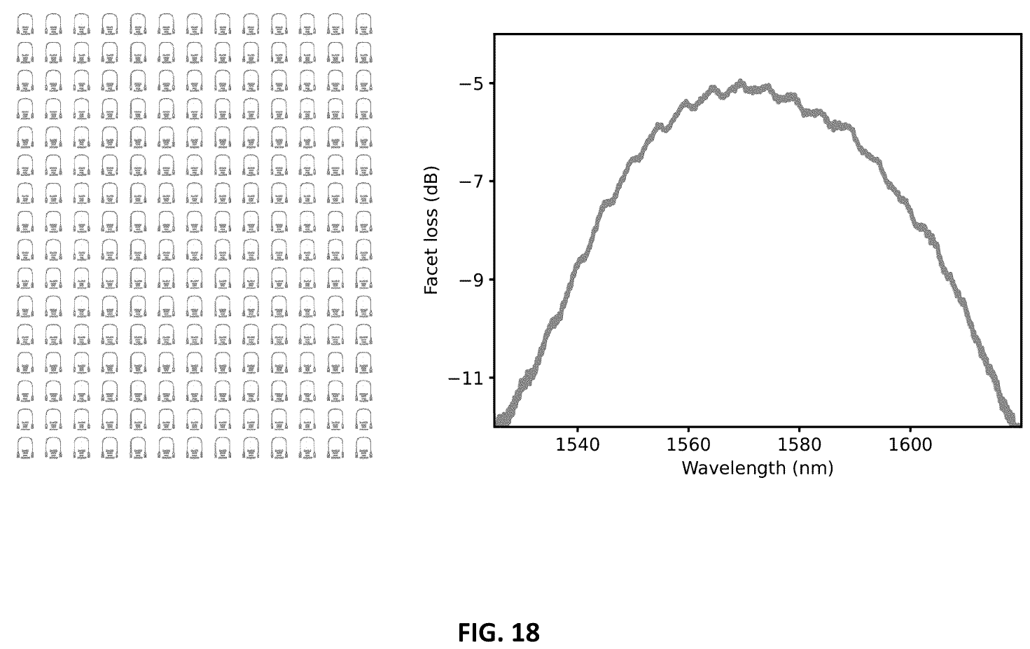

To efficiently couple light into the circuit, high-efficiency grating couplers were designed and fabricated with a low insertion loss of 4.95 dB/grating. This loss was still a major contribution to the overall insertion loss. Optimization with a chirped design increased the grating coupler efficiency to 0.89 dB/grating. Switching to edge coupling approaches further improved the coupling efficiency to 0.54 dB/facet. The transmission spectrum may depend on the wavelength used to perform the alignment for these grating couplers. For example, if a pump is used at 1600 nm to perform the alignment, the transmission spectrum may be worse than the spectrum aligned with a pump at 1565 nm. This could be due to the use of a focusing grating with adiabatically bending. Because of this, when designing and characterizing such grating couplers, several iterations of alignments may be needed to find the wavelengths used for alignment which yield maximum optical transmission and optimal spectrum. FIG. 18 depicts a grating coupler design, in accordance with various embodiments. As shown, a highest transmission of −4.95 dB/facet is achieved.

### Fan-Out Splitting Trees

An efficient fan-out splitting tree may important for the large-scale TFLN circuit described herein. To ensure highly-efficient 50-50 splitting at each node, Y splitters were used as the 50-50 splitter, due to its high fabrication tolerance and low insertion loss. Furthermore, to ensure low loss within the connection of the tree nodes, the connection was designed using Euler curves to minimize any possible loss. By measuring the transmission at each port, an average insertion loss of 0.135 dB was extracted per branch for the tree.

### Matrix-Vector-Multiplications: Experimental Scheme and Concept

### Architecture and Setup

Matrix-vector-multiplication operations (MVMs) in the thin-film lithium niobate (TFLN) circuit, described herein, may rely on the cascaded, high-speed, amplitude modulation of light. Continuous wave (CW) light in the telecommunications C-band may be coupled into the circuit via grating couplers. This light may pass through an initial amplitude modulator (AM) which encodes the data vector \vec{x} onto the light's amplitude. This light may then undergo splitting via the on-chip fan-out splitting tree, each passing through a second AM, which, when driven in time-synchrony with the data-encoded light stream, may apply the weight vector \vec{a} and may achieve a total amplitude encoding corresponding to the independent components contributing to \vec{x}·\vec{a}. Finally, this light may be coupled off the chip and detected by low-noise, high-speed photodetectors. The photocurrent amplitude may track the patterned amplitude fluctuations of the impinging light up to its detection bandwidth, and the components contributing to \vec{x}·\vec{a} may be directly read-off by an oscilloscope. The electronic summation of the components may yield \vec{x}·\vec{a}. The electronic signals reflecting \vec{x} and A may be generated by arbitrary waveform generators (AWG) and delivered to the chip-based AMs using high-speed cables and contact probes.

### Electro-Optic Amplitude Modulation and Working Principle

Here, one branch of the spatial fan-out was used, which included two cascaded AMs, as an example of the basic working principle. The AM utilized a Mach-Zehnder interferometer (MZI) and a triplet of ground-signal-ground traveling wave coplanar electrodes. This design formed AMs in the push-pull configuration, allowing a reduction in the π-voltage (V_{π}) by a factor of 2 compared to their phase modulator (PM) counterparts⁴. The V_{π} was the amount of voltage required to shift the optical phase from ϕ to ϕ+π (switch the optical amplitude from 0 to 1) for the case of a PM (AM). MZI-based AMs may have a transfer function

$$T ( V ) ∼ \frac{1}{2} ( 1 + sin π \frac{V}{{V}_{π}} ) ,$$

where V is the voltage applied to the AM. When these AMs are operated at the quadrature point

$$( T = \frac{1}{2} ) ,$$

T may be linear in v for small V. Since T may fully determine the extent of amplitude modulation, in this regime any applied voltage may be transferred linearly onto the amplitude of light with high fidelity. This may form the basis of amplitude-modulated communications and may be the working principle of the photonic MVM accelerator which cascades AMs for MVM operation.

Driving a single AM with a data stream of voltages V(t), the output transmission may be

$$P ( t ) = T \cdot {P}_{0} = \frac{{P}_{0}}{2} + \frac{{P}_{0}}{2} π \frac{1}{{V}_{π}} V ( t )$$

with P₀ is the power of the input light. As a result, the total transmission of two cascaded AMs may be be written as P(t)=T₂·T₁. P₀, in which T₁ and T₂ are the transfer functions of the first and the second AM. When the first modulator is modulated with data stream Vₓ(t) and the second modulator is at quadrature point without modulation, the transmission may become

$$P ( t ) = {T}_{2} \cdot {T}_{1} ( {V}_{x} ( t ) ) \cdot {P}_{0} = \frac{1}{2} \cdot \frac{1}{2} ( 1 + sin π \frac{{V}_{x} ( t )}{{V}_{π}} ) \cdot {P}_{0} .$$

When this signal is received on a photodetector (operated in the linear i.e., non-saturated regime), the generated photocurrent/(t) may be written as

$$\frac{1}{2} \cdot ( {C}_{1} \cdot {V}_{x} ( t ) + {C}_{2} ) \cdot {P}_{0} \cdot η$$

with a proportionality constant C₁, constant offset C₂, and η, that account for the lumped linear response of all components in the detection and readout chain. The oscilloscope may then read a linearly proportional voltage Iₓ(t)·R where R may be either the internal resistance of the oscilloscope or the photodetector, depending on the photodetector in use. Similarly, driving the second AM with a data stream of voltages Vₐ(t′) with the first AM operated at quadrature, the original input light may becomes

$$P ( t ) = {T}_{2} ( {V}_{a} ( {t}^{′} ) ) \cdot {T}_{1} \cdot {P}_{0} . = \frac{1}{2} ( 1 + sin π \frac{{V}_{a} ( t )}{{V}_{π}} ) \cdot \frac{1}{2} \cdot {P}_{0} .$$

The photocurrent may be parametrized by another pair of constants C₃ and C₄, such that

$${I}_{a} ( {t}^{′} ) = ( {C}_{3} \cdot {V}_{a} ( {t}^{′} ) + {C}_{4} ) \cdot \frac{1}{2} \cdot {P}_{0} \cdot η ,$$

and the oscilloscope voltage may be Iₐ(t′). R. Indeed, these coefficients C₁, C₂, C₃, and C₄ may be important for achieving the first order mapping between detected oscilloscope voltages and the multiplication of elements xᵢaᵢ, which may be the terms in the vector-vector dot product. When both modulators are driven together and the photonic MVM accelerator is operating, the oscilloscope voltage may be P(t, t′)=T₂(Vₐ(t′))·T₁(Vₓ(t))·P₀=(C₃·Vₐ(t′)+C₄)·(C₁·Vₓ(t)+C₂)·P₀·η·R. Importantly, t,t′ may be separate temporal axes offset by a time delay τ. This τ may be the propagation-induced delay of the amplitude-modulated signal, specifically, the time difference between its arrival time at the second weight-modulator and its departure time from the first data-modulator. When Vₐ(t′) is such that t′=t+τ, both time axes may be unified and t′→t. Provided adequate calibration of τ, the oscilloscope voltage may be written as P(t)=T₂(Vₐ(t))·T₁(Vₓ(t))·P₀=(C₃·Vₐ(t)+C₄)·(C₁·Vₓ(t)+C₂)·P₀·η·R=(C₁C₂·Vₐ(t)Vₓ(t)+C₁C₄·Vₓ(t)+C₂C₃·Vₐ(t)+C₂C₄)·P₀·η·R. For clarity, the four products of coefficients may be scaled by P₀·η·R and redefined such that α→C₁C₂P₀·η·R,β→C₁C₄P₀·η·R,γ→C₂C₃P₀·η·R, and δ→C₂C₄P₀·η·R. The measured voltage corresponding to vector-vector operations may be finally defined as

$${V}_{readout} ( t ) = α \cdot {V}_{a} ( t ) {V}_{x} ( t ) + β {V}_{x} ( t ) + γ {V}_{a} ( t ) + δ , \qquad ( S1 )$$

where α, β, γ, and δ may be the calibration coefficients to be experimentally determined. Clearly, if the data and weight vectors are represented by Vₓ(t) and Vₐ(t) respectively, then the readout voltage may give access to the product Vₐ(t) Vₓ(t) which may be the quantity of interest.

### Matrix-Vector-Multiplications: Experimental Details

### Calibration of α, β, γ, and δ

Assuming an end-to-end, linear model for the photonic MVM accelerator, there may be four coefficients that parametrize each computation, α, β, γ, and δ. A simple method was devised, to compute these coefficients, using a constant amount of optical computational resources (equivalent to a vector-vector dot product of size 8), regardless of the size of the vectors involved in the actual computation.

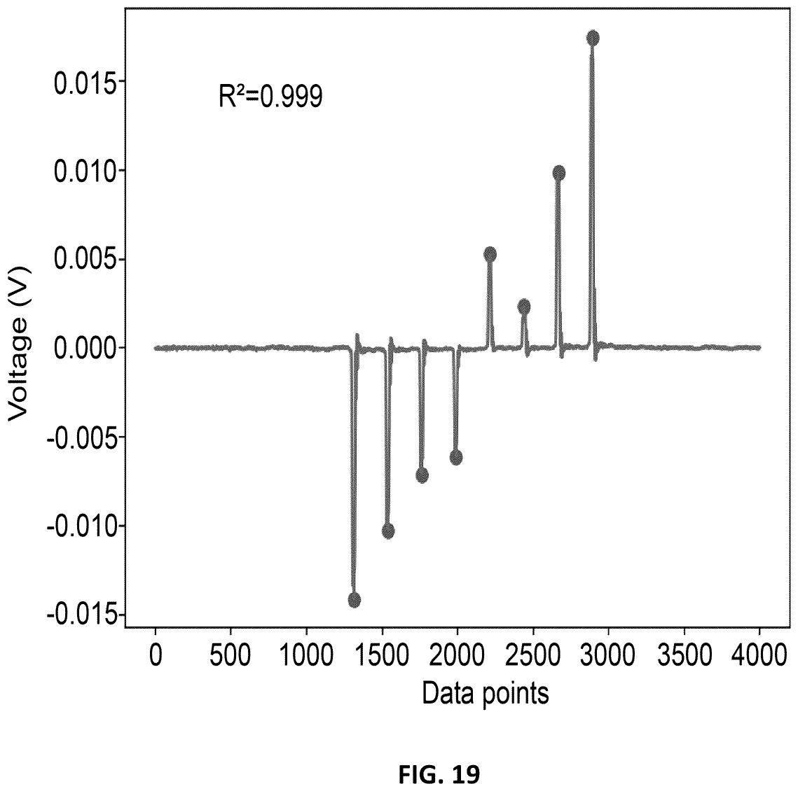

Examining equation (S1), only sampling V_{readout} may be needed at a few combinations of Vₐ and Vₓ. Size-8 vectors of Vₐ=[−1, −1, −1, 0, 0, 1, 1, 1] and Vₓ=[−1, 0, 1, −1, 1, −1, 0, 1] were constructed and the size-8 V_{readout} result was recorded. Note that −1 may map to Vₘᵢₙ, the minimum drive voltage for modulator linearity to hold, and +1 may map to Vₘₐₓ, the maximum drive voltage for modulator linearity to hold. 0 may map to the midpoint of Vₘᵢₙ and Vₘₐₓ. Note that there may be no Vₐ=0, Vₓ=0 pair because the constant detector background may amply sample this case. Note that this case may correspond directly to the constant offset δ. Provided the triplet of size-8 vectors Vₐ, Vₓ, and V_{readout}, a three-parameter linear least-squares fit to this small data set may be used to obtain α, β, and γ. Typical R²-coefficients of these fits may be greater than 0.99, which can also be used as an indicator for adjusting the system towards the linear regime. Once these four parameters are obtained, they may be used to extract the vector-vector dot product, as discussed further below. FIG. 19 depicts calibration, in accordance with various embodiments. In particular, a calibration of α, β, γ, δ with R²=0.999 is shown in FIG. 19.

### Compensation of Systematic Nonlinearities

As in any electronic ADC system, systematic nonlinearities in the photonic MVM accelerator may exist. While the small signal approximation may allow for the approximation of a linear transfer function in the vicinity of the AM quadrature point, small nonlinearities at maximum and minimum voltages may remain. In commercial ADC systems, lookup tables may be required to correct for nonlinearities especially at the endpoints of the signal range. In the eperiments described herein, a lookup table f was contructed for the photonic MVM accelerator. Conveniently, this f may be characteristic to a pair of data and weight modulators, and it may be fixed throughout instances of large-scale inference tasks (nonlinear classification, MNIST handwritten digit recognition, CIFAR-10 photo classification) performed in what is described herein. The lookup table f may be equivalent to a special nonlinear activation that is performed by an electronic computer, which may not require parallel processing and the power overhead may be insignificant in the current computing architecture. Once the lookup table is determined, it may be be stored permanently and called for every computation with negligible power consumption. Intrinsic nonlinearities in the systems described herein may be exploited for nonlinear activation.

The construction of f may be straightforward. First, random vector pairs of length consistent with the length of data and weight vectors of interest are generated. These vector pairs may have randomized elements scaled to have dot products targeting a uniform spread of values between −1 and +1, on average. The optical dot products may then fitted to the electronic dot products (ground truth) using a polynomial. The number of samples fitted may be much larger than the highest order of polynomial fitting considered to prevent overfitting.

### Scaling \vec{x} and \vec{A}

Any computing task involving \vec{x}·\vec{a} may be treated by mapping it to normalized variables such as \hat{x}·â where all vector elements \hat{x} and â may be bounded above and below by +1 and −1, respectively. The normalization process may involve a simple rescaling such that \vec{x}=k₁\hat{x} and \vec{a}=k₂â, where k₁=max/i(xᵢ, xᵢ∈\vec{x}) and k₂=max/i(aᵢ, aᵢ∈\vec{a}). This normalization may be convenient, because the same interval [−1,1] is mapped to slightly different

$$[ {V}_{min}^{0} , {V}_{max}^{0} ] , [ {V}_{min}^{1} , {V}_{max}^{1} ] … [ {V}_{min}^{16} , {V}_{max}^{16} ] ,$$

i.e., the range of encoding voltages such that the 16 weight-AMs may be linear. This scaling may be further consistent with conventional definitions of computational accuracy, as is dscribed in a later part of this section.

Other normalization schemes such as scaling towards a target interval of [0,1], [−1,0], or scaling with offset schemes to create \hat{x}, â that maximally utilize the full voltage range per AM may be possible. A subset of these schemes was considered in the experiments described herein, though regardless of the one chosen, the final MVM result may be consistent with each other.

Computing Vector-Vector Multiplication \vec{x}· \vec{a}

The experimentally accessible quantity in equation (S1) may always be V_{readout}(t), provided a set of calibration coefficients and the electronically generated Vₐ(t) and Vₓ(t). If the data vector \vec{x} is flattened into a temporal list of voltages Vₓ(t) and the weight vector a into Vₐ(t), then the useful list of voltages may be Vₐ(t) Vₓ(t) which is contained in V_{readout}(t). Therefore, with each computation of

$$\vec{x} \cdot \vec{a} , {V}_{a} ( t ) {V}_{x} ( t ) = \frac{1}{a} ( {V}_{readout} ( t ) - β {V}_{x} ( t ) - γ {V}_{a} ( t ) - δ )$$

may be required. The Vₓ(t) and Vₐ(t) can be directly accessed from the original vector \vec{x} and \vec{a}, or via the temporal list of voltages prior uploading to the AWG, or they may be optically accessed via separate computations. Specifically, Vₓ(t) may be optically accessed via

$$\frac{1}{β} ( {V}_{r eadout} ( t ) - δ )$$

by setting the weight modulator Vₐ(t)=0; and Vₐ(t) may be optically accessed via

$$\frac{1}{γ} ( {V}_{readout} ( t ) - δ )$$

by setting the data modulator Vₓ(t)=0. Note further that α, β, γ, and δ are known may always be assumed, according to the calibration process described in an earlier part of this section. The first and second method may introduces an O(n) overhead in number of digital floating-point operations (fundamentally limited by the clock-speed), while the third method may introduce an O(n) overhead in number of optical operations (fundamentally limited by electro-optic modulator bandwidth provided sufficiently fast detection methods), where n is the size of the computation. The implementation of the first and second approach may require specifically designed electronic circuits. Towards all-optical MVM for a proof-of-concept demonstrations, as describe herein, the third method may be adopted. Once Vₐ(t) Vₓ(t) is obtained, O(n) floating point operations may be required to digitally accumulate all levels in the time series. This summation may then be passed through the lookup table f and scaled back by ab to yield the optically-computed dot product

$${( \vec{x} \cdot \vec{a} )}_{o} = ab \cdot f ( \sum {V}_{a} ( t ) {V}_{x} ( t ) )$$

Integrated electronics may be used in place of the electronic accumulation 2. The lookup table f may be customary in all electronics such as high-speed ADCs to compensate for nonlinearities in the system, and such methods may be routinely employed in photonic MVMs described herein as well.

### Computing Matrix-Vector Multiplication A·\vec{x}

Each computing unit, consisting of a data and weight modulator, may perform

$${\vec{a}}_{i}^{T} \cdot \vec{x} ,$$

where

$${\vec{a}}_{i}^{T}$$

is the ith row of matrix A. The length of vectors may only limited by the memory length of the AWG owing to multiplexing in the temporal domain. If the vectors exceed this length, they may be broken up into subproblems and tackled by multiple computing units. This type of photonic MVM accelerator may support computations over continuously updating data streams at the claimed speed, due to the high-speed modulation. In all large-scale inference tasks completed, as described herein, the memory length may be sufficient for each computing unit to handle one vector-vector multiplication at a time. In fully-connected DNNs, neurons (represented by vectors) between layers may be connected by weights (represented by matrices). For example, the kth layer may be represented by a data-vector \vec{x}ₖ and full connectivity may be established with the (k+1)th layer via Aₖ. The quantity

$${\vec{a}}_{k , i}^{T} \cdot {\vec{x}}_{k}$$

may give precisely the ith component of \vec{x}ₖ₊₁, minus any nonlinear activations. Therefore, one computing unit may establish the components of the next layer one at a time. To achieve the maximum computational speed offered by the photonic MVM accelerator described herein, the matrix-vector multiplication may be broken down into vector-vector multiplications. The data vector may be applied to the initial data modulator and weight vectors may be separately broadcast to the array of weight modulators, achieving a multiplexing factor consistent with the spatial fanout factor.

### Nonlinear Activation

Another important feature in DNNs may be the nonlinear activation function applied component-wise to A·\vec{x}. While this may not be central to the photonic MVM accelerator described herein (nonlinear activation may be O(n) per layer and does not truly bottleneck electronic DNN architectures), all-optical or detection-based nonlinearities may be actively explored by the community, towards achieving analogs of popular nonlinear activations such sigmoid, soft-max, and regularized-linear-unit (ReLU). In what is described herein, all nonlinear activations may be electronically applied to optically computed vector-vector dot products.

### Computational Accuracy

### Definition of σ

In IEEE 64-bit floating-point arithmetic, the machine precision ϵ_{machine}˜10⁻¹⁶ may be defined by flop(x⊙y)=x⊙y(1+ϵ_{machine}), where flop(·) denotes a floating-point operation. Following this definition, the computational accuracy may be defined as the absolute error in computing a result bounded by magnitude 1. This may be consistent with the normalization scheme described in an earlier part of this section, since the computational accuracy directly characterizes the absolute error in the normalized regime.

The computational accuracy may be determined, for a given power budget (pJ/OP), by generating many pairs of random vector pairs. These vector pairs may have randomized elements scaled to have dot products targeting a uniform spread of values between −1 and +1, on average. Optical vector-vector dot products for each pair may be tabulated according to the experimental procedure leading up to equation (2). The differences between these values and their electronically computed counterparts form the histograms in FIG. 13D of descirbed herein, and the standard deviation of these distributions may be directly quoted as a percentage, representing the computational accuracy. All V_{readout}(t) may be collected by averaging 10 times to eliminate residual electronic noise in the system.

### σ Dependence on Energy Consumption and Clock Rate

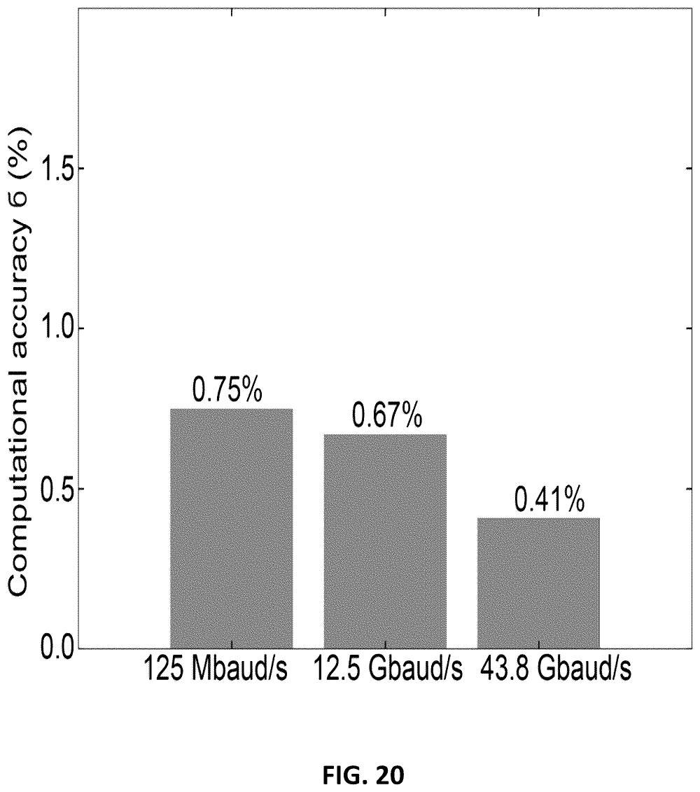

In FIG. 13D described herein, the computational accuracy σ was systematically characterized at different computing speeds. There, each vector symbol was represented by 2 AWG samples, amounting to 22.8 ps/Sa or 43.86 Gbaud/s bandwidth. By attenuating the optical power (+4, −4, and −17 dBm, FIG. 3d left, middle, right panels), σs was separately measured without significant degradation in σ. To supplement this result, σ was also studied at 43.8 Gbaud/s, 12.5 Gbaud/s, and 125 Mbaud/s, respectively. There may be no fundamental limitation behind the variation of σ under different speeds. These σs can be improved by further optimizations and tuning system parameters to achieve the best condition under each baud rate. In experiment, σ<1% was sufficiently low to demonstrate highly accurate inference tasks. Notably, the best-case σs under these speeds was the case at 43.8 Gbaud/s, suggesting that high-speed data encoding and computation, down to tens of ps per sample, may not present immediate limitations to photonic MVM accelerators in the TFLN electro-optic platform. FIG. 20 depicts computational accuracy for different speeds, in accordance with various embodiments.

### Long Term Stability

### Stability Measurement

The long-term stability of the photonic MVM accelerator, described herein, may be directly probed by repeatedly computing the same vector-vector dot product for >20 hours (see FIG. 15C). The optical dot product may be compared against the electronic ground truth throughout the stability measurement. Any short-term fluctuation may manifest as local perturbations in the curve, and any long-term drifts may manifest as a gradual offset from perfect optical-electronic agreement (zero error). The curve may have neither local perturbations nor gradual offsets. Instead, in the experiments described herein, it was fluctuating with a standard deviation of 0.04% around zero error, indicating that the accelerator is stable. Thecalibrations (α, β, γ, and δ) may correct for both short- and long-term sources of error, and the lookup table f is responsible for correcting systematic nonlinearities in the detection pathway. More importantly, integrating all components in the same chip may enable a robust optical and microwave system that is insensitive to outside vibration or temperature changes. Working together, long-term stability may be achieved.

### Multiplexing Computations

Two dimensions used for the massively parallel, general-purpose matrix-vector computations described herien may be space and time. This may perhaps not be surprising, considering the rapidly maturing TFLN electro-optics photonic integrated circuit (PIC) platform. on the following includes comments on both aspects and discusses future opportunities for multiplexing in the wavelength domain.

### Spatial Multiplexing

Since the pioneering work on chip-scale, TFLN electro-optic modulators in 2018, fabrication technology has continuously matured, and high-throughput, wafer-scale processing may be on the horizon. As described herein, spatial multiplexing may be achieved by virtue of the highly reproducible fabrication of 32 low-V_{π}, high-bandwidth electro-optic AMs over a 2.2 by 3.6 cm chip area. Low loss on-chip routing and splitter trees were integral to perform 16-channel spatial multiplexing of CW light, and equivalently high-performing electro-optic AMs were required. Indeed, for each of the 16 channels corresponding to one data and weight modulator pair, the grating coupler for that neuron out coupled roughly the same amount of power despite slightly different propagation lengths, indicating both well-designed 50-50 splitting ratio, low-loss power splitting, and low-loss propagation. The splitter tree loss amounts to 0.13 dB per arm on average, and the propagation loss extracted from microring resonators fabricated on the same chip was about 0.28 dB/cm. The V_{π} of the modulators was ˜2.2 V·cm, measured using a 1 MHz sawtooth modulation. The modulator 3-dB bandwidth (after removing contact probe, cable, and photodetector contributions) was consistently above 40 GHz with 20 dB suppressed reflections (S11 and S21 parameters measured from VNA) for all 31 modulators with only 1 modulator dead during fabrication. Thus, what is described herein leverages the near-unity-yield production of a low-loss TFLN photonic integrated circuit (PIC) fabricated in a non-industrial setting. Importantly, the high-performing photonic MVM accelerator, given the extent of spatial multiplexing, represents the largest TFLN PIC (over 300 components) to-date.

### Temporal Multiplexing

3-dB bandwidths greater than 40 GHz may offer massive multiplexing in the temporal domain. This unique ability of TFLN modulators may render the temporal domain as a natural one for parallelization. As shown in FIG. 13C, high fidelity encoding of 43.86 Gbaud/s data (22.86 ps per vector element) may be possible and the extracted voltages may closely follow the theoretically expected amplitude modulations. Efficient, fast modulation may mean denser data (less time per vector element) without sacrificing encoding fidelity. In principle, electro-optic amplitude modulation may be limited at the physics level down to fs time-scales (material nonlinear-optical response time). Practically, it may be limited by the modulator V_{π} and 3-dB bandwidth (electromagnetic losses of high-frequency radio-waves and velocity mismatch). Current state-of-the-art chip-scale TFLN modulators fabricated through photonic foundry tape out processes may achieve over 100 GHz 3-dB bandwidths with a V_{π} of 1 V. This may further push the computational speed beyond what is demonstrated in this work, towards a 200 Gbaud/s-clocked (5 ps per vector element) photonic MVM accelerator.

### Wavelength Multiplexing

TFLN may be a highly versatile platform for nonlinear photonics, with both χ⁽²⁾ and χ⁽³⁾ nonlinearities. It can generate both χ⁽²⁾ and χ⁽³⁾ combs such as resonant electro-optic combs and dissipative Kerr solitons. These native comb sources may represent a commonly used degree of freedom, wavelength (frequency). It may be challenging to truly utilize the wavelength dimension in a high-speed and efficient way, without an integrated multiplexer and demultiplexer, and even so it may be hard to avoid spatially separate channels, which requires spatial multiplexing again. Furthermore, the current pump-to-comb conversion efficiency of on-chip comb sources may be another bottleneck towards efficient wavelength multiplexed computing.

One way to envision wavelength domain multiplexing to be useful for the amplitude multiplication architecture may be when a spatial multiplexing factor orders of magnitude larger than 16 is desired, and power splitting simply may not provide enough signal-to-noise ratio even with amplification on the receiver end. In this case, one may arbitrarily supply more input light, or utilize multiple frequencies. While additional spatial multiplexing and the multiplexing/demultiplexing of a comb source may not be avoided to do wavelength multiplexed computations, it may offer further parallelization when spatial multiplexing under a single wavelength is saturated.

### Machine Learning Model

The TFLN photonic MVM accelerator, described herein, may be a general-purpose processor and suitable for any task that requires large-scale matrix-vector multiplications, such as propagating test data through fully-connected DNNs to perform inference on those data sets. To this end, three machine learning tasks were demonstrated utilizing heavy MVMs performed by the photonic accelerator descrbied herein: binary classification, MNIST handwritten digit recognition, and CIFAR-10 photo classification. These tasks are ordered in increasing difficulty, by the criteria of more MVM per inference.

Due to limited accessibility of a high-speed oscilloscope, and given that the main goal of demonstrating these machine learning algorithms may be to show that the computation is accurate enough to perform complex and realistic algorithms instead of further showcasing the high speed that may already be proven in FIG. 13, the machine learning tasks in the main text were performed at a clock-rate of 125 MBaud/s (8 ns per vector element) using one pair of cascaded modulators. It is emphasized that the tasks were performed at this rate due to the equipment availability and not due to any limitations of high-speed MVMs. With a loaned high-speed oscilloscope, it was shown that running the same operations at 43.8 Gbard/s resulted in the same computational accuracy as that at 125 MBaud/s (see section “computational accuracy” for details). Training was done electronically, and the photonic MVM accelerator performed inferences on test data based on trained weights.

### Binary Classification

A simple model was built for the “exclusive-or” dataset, a classic example of nonlinear classification. The data sets were two-dimensional vectors \vec{xₗ}=[x_{i.1}, x_{2,i}]^{T} such that x_{i.1}, x_{2,i}∈[−1, 1], and labeled yᵢ=1 (True) if and only if exactly one of x_{i,1},x_{i,2} is positive. Otherwise, if x_{i,1},x_{i,2} are same sign, then yᵢ=0 (False). A five-parameter kernel model was developed, in the form of

$${\tilde{y}}_{i} = {( {\vec{x}}_{i} - \vec{m} )}^{T} \cdot Q \cdot ( {\vec{x}}_{i} - \vec{m} ) , \qquad ( S3 )$$

where the five parameters were contained in \vec{m} and Q:

$$\vec{m} = ( \begin{matrix}{m}_{1} \\ {m}_{2}\end{matrix} ) , Q ( \begin{matrix}{q}_{1} & ρ \\ ρ & {q}_{2}\end{matrix} ) .$$

For each two-dimensional test vector, 3 MVMs were required for its accurate classification. Matrix-vector and vector-vector multiplications in equation (S3) was performed over 400 test vectors sampled in the problem domain. As shown in FIG. 14, the photonic MVM accelerator described herein achieves about identical performance compared to its electronic counterpart.

### MNIST Handwritten Digit Recognition

A DNN model was built using the Python-based API Keras as a classifier for handwritten digits within the MNIST dataset. This dataset consisted of 70,000 black and white images of ten numbers, 0-9. Each image was 28 by 28 and was flattened into size n=784 vectors. These vectors were the inputs of a single-layer fully-connected network (no hidden layers), where the single layer was of size n=10. For each image, 10 MVMs were performed followed by an electronic softmax nonlinear activation. Here, correct MVMs were required for the accurate classification of a single test image. As shown in the representative example in FIG. 15A and the confusion matrix in FIG. 15B over 500 MNIST test images, the photonic MVMs accelerator described herein achieves remarkable agreement with the electronic computations which are ground truth.

### CIFAR-10 Photo Classification

A convolutional neural network (CNN) model was built using the Python-based API Keras as a classifier for photos within the CIFAR-10 dataset. This dataset consisted of images among ten categories (integer labels): airplane (0), automobile (1), bird (2), cat (3), deer (4), dog (5), frog (6), horse (7), ship (8), and truck (9). Each image consisted of red, blue, green layers of size 32 by 32. A simple CNN model was developed in Keras to classify these images. The CNN model consisted of initial convolutional processing of the image tensors (32 by 32 by 3) into size n=1024 vectors. These vectors were the inputs of a two-layer fully-connected network (one hidden layer), where the two layers were of size n=128 and n=10.

The convolutional processing of test tensors into vectors was done electronically, while propagation through the fully-connected network was computed using the photonic MVM accelerator described herein. For each image, it first underwent electronic convolutional processing through 6 convolutional layers (all with sliding square kernels of dimension 3 and ReLU nonlinear activation), with max pooling and dropout in between convolutional layers. Once the test tensors were flattened into size-1024 vectors, 138 MVM were performed, followed by electronic ReLU and softmax nonlinear activations when appropriate. Therefore, 138 correct MVM were required for the accurate classification of a single test tensor (an order of magnitude more MVM compared to MNIST classification, per image). The remarkable agreement between electronics and optics, as shown in FIG. 15D of the main text, strongly supports the computational accuracy of the photonic MVM accelerator.

### System Characterization: Speed and Energy Consumption Calculations

The energy consumption (energy per operation, in the unit of pJ/OP), denoted as η, may be defined as η=Power/Speed. In the circuit described herein, the total energy consumption comprised contributions from the modulator, optical power from the laser, and detector. Specifically, they were calculated by:

Modulator power P_{mod}: This was derived from the voltage Vᵣₘₛ output from the driving equipment and was given by

$${P}_{m o d} = \frac{{V}_{r m s}^{2}}{R} with R = 50 Ω .$$

Optical power Pₒₚₜ: This Pₒₚₜ was the required input optical power. The laser wall plug conversion efficiency ϵₗₐₛₑᵣ was not included, given that a benchtop laser (Santec TSL-570) was used without optimization on ϵₗₐₛₑᵣ, for proof of concept demonstration. Currently, an optical energy consumption of ηₒₚₜ=0.041 pJ/OP and a total energy consumption of ηₜₒₜₐₗ=0.099 pJ/OP without including ϵₗₐₛₑᵣ was reported. If quoting a conventional ϵₗₐₛₑᵣ=20% for laser^{15,16}, an optical energy consumption of ηₒₚₜ=0.204 pJ/OP and a total energy consumption of ηₜₒₜₐₗ=0.262 pJ/OP may be achieved, which does not create significant increase on the overall energy consumption.

Detector power P_{PD}: This was estimated by P_{PD}=V_{bias}×k_{PD}×P_{opt,PD}, in which k_{PD}=0.65 A/W represented the responsitiviy of the detector, V_{bias}=2.8 V was the bias voltage, and P_{opt,PD} was the optical power entering the detector. The detector ias a biased non-amplified photodiode.

The total energy consumption (energy per operation) was given by

$$η = {η}_{m o d} + {η}_{opt} + {η}_{PD} = \frac{( {P}_{mod} + {P}_{opt} + {P}_{PD} ) \times M \times N}{M \times N \times v} = \frac{( {P}_{m o d} + {P}_{opt} + {P}_{PD} )}{v} ,$$

in which v=43.8 GOPS per channel. This indicated that the total energy per operation remained the same with an increase in channel numbers, as the speed and power scales proportionally. See detailed parameters in Table 1.

The outlook performance in Table 1 was evaluated using the already achieved state-of-the-art TFLN components, including modulators with V_{π}·L of sub−1V·cm, waveguides with 0.03 dB/cm propagation loss, and an edge coupler with 0.5 dB/facet coupling loss. The number of overall channel (Mx N) were estimated as 700, calculated by assuming the devices take half of the wafer area, i.e.

$$\frac{1}{2} \frac{Area of 4 inch wafer}{Area per modulator} ,$$

with the area of a single modulator being estimated as 0.5×10 mm².

TABLE 1
Characterization of the system as well as power and speed calculations

| | | | This work, | |
|---|---|---|---|---|
| | | | outlook using | |
| | This work, | | already achieved | |
| Parameters [per channel] | currently | | state-of-the-art | |
| Splitter tree loss | 0.135 | dB | 0.1 | dB |
| Propagation loss | 3.485 | dB | 0.5 | dB |
| Facet loss (two facets) | 2 × 4.95 | dB | 2 × 0.5 | dB |
| Modulator loss due to quadrature point | 2 × 3 | dB | 2 × 3 | dB |
| Total insertion loss per channel | 19.52 | dB | 7.6 | dB |
| Required optical power from laser Pₒₚₜ | 2.52 | dBm | −13 | dBm |
| Total energy consumption on laser ηₒₚₜ | 0.041 | pJ/OP | 0.251 | fJ/OP |
| Modulation voltage Vᵣₘₛ from driving | 354 | mV | 71 | mV |
| equipment | | | | |
| Total energy consumption on modulator | 0.057 | pJ/OP | 0.5 | fJ/OP |
| Power η_{mod} | | | | |
| Total optical power at detector | −17 | dBm | −20.6 | dBm |
| Photodetector responsitivity | 0.65 | A/W | 0.65 | A/W |
| Photodetector bias voltage | 2.8 | V | 2.8 | V |
| Total energy consumption on | 0.001 | pJ/OP | 0.079 | fJ/OP |
| photodetector η_{PD} | | | | |
| Number of channel | 31 | | 700 | |
| Speed ν | 43.8 GOPS per | | 200 GOPS per | |
| | channel | | channel | |
| Total speed of the circuit νₜₒₜₐₗ | 1.36 | TOPS | 140 | TOPS |
| Total energy consumption ηₜₒₜₐₗ | 0.099 | pJ/OP | 0.83 | fJ/OP |
| Total energy efficiency (1/ηₜₒₜₐₗ) | 10.2 | TOPS/W | 1205.0 | TOPS/W |

### Performance and Comparisons

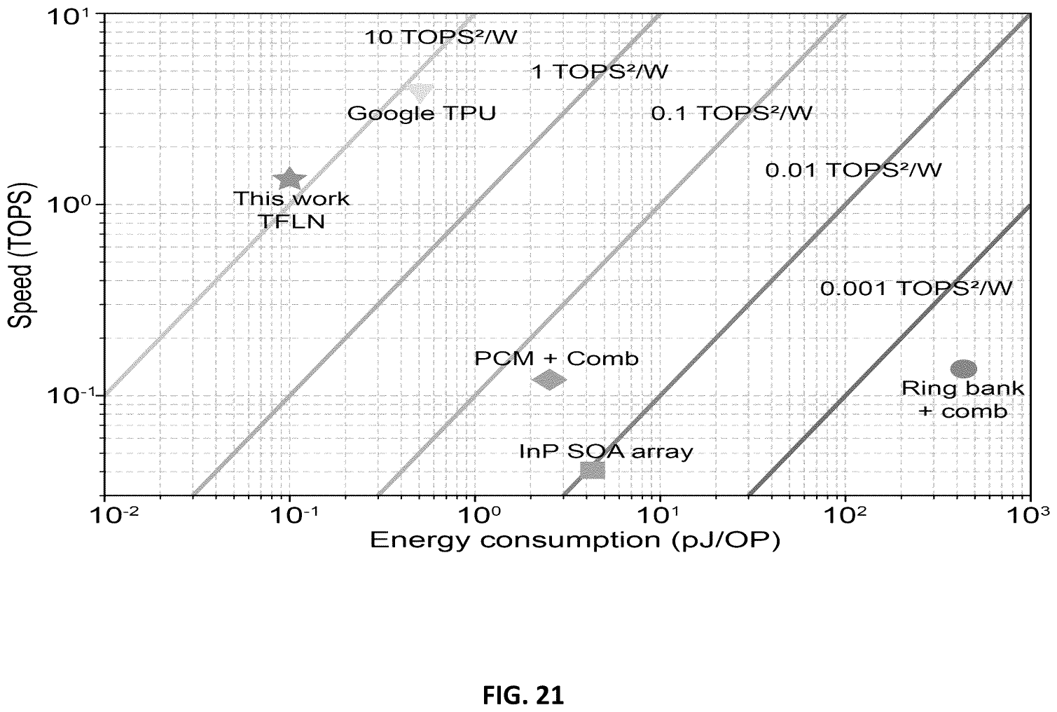

Compared to previous works, what is described herein offers advantages in terms of power and speed (see FIG. 21). It may be critical to consider both power and speed together for practical computing applications, as excelling in one aspect but not the other is insufficient. A performance of 1.36 TOPS at an energy efficiency of 0.099 pJ/OP (i.e. 10.2 TOPS/W) has been shown. This translated into a speed-energy-efficiency product of 13.87 TOPS²/W. Such a performance was not only a record high for integrated photonic computing systems but also marks the first instance where integrated photonic chips have achieved performance comparable to state-of-the-art electronic systems, like the Google TPU, which stands at 8 TOPS²/W. Note that this comparison did not include works that utilize free space optics. Those systems typically either may use single-shot measurements that do not demonstrate continuous processing of an updating data stream, or they may rely on non-integrated approaches requiring massive bulk optics components. As a result, works that are able to perform continuous processing with the ability of integration are focused on in FIG. 21. Works that only report either energy efficiency or speed are also not included in FIG. 21.

A full list of performances can be found in Table 2. The compatibility of integration in Table 2 may be determined by whether the system contains parts that require free space bulk components (such as lenses or phase masks for computation) or requires free space processing for encoding data on the input light. FIG. 21 depicts a comparison of speed and energy consumption, in accordance with various embodiments. For example. FIG. 21 shows a comparison between a Google TPU, a PCM+comb, an InP SOA array, and a Ring bank+comb.

TABLE 2
Performance comparison. TFLN: thin-film lithium niobate; PCM: phase change materials; Si:
silicon; InP: indium phosphide; SiN: silicon nitride; AlGaAs: aluminium gallium arsenide;

| | | | Continuous | | |
|---|---|---|---|---|---|
| | | Energy | processing with | | |
| | Speed | consumption | updating data | | |
| Reference | (TOPS) | (pJ/OP) | stream | Integrated | Platform |
| This work | 1.36 | 0.099 | Yes | Yes | TFLN photonics |
| Google TPU²⁹ | 4 | 0.5 | Yes | Yes | Electronics |
| Feldmann et al | 0.12 (a) | 2.5 | Yes | Yes | Si/SiN photonics + |
| 2021³⁰ | | | | | PCM |
| Bai et al | 0.138 | 434.78 | Yes | Yes | AlGaAs + Si |
| 2022³² | | | | | photonics |
| Shi et al | 0.04 | 4.2 | Yes | Yes | InP photonics |
| 2020³¹ | | | | | |
| Huang et al | 4.4 × 10⁻⁵ | N/A | Yes | Yes | Si photonics |
| 2021³³ | | | | | |
| Xu et al 2021³⁴ | 2 × 10⁻¹⁰ | N/A | Yes | Yes | Si photonics |
| Zhang et al | N/A | N/A | Yes | Yes | Si photonics |
| 2021³⁵ | | | | | |
| Zhu et al | N/A | N/A | Yes | Yes | Si photonics |
| 2022³⁶ | | | | | |
| Pai et al 2023³⁷ | N/A | N/A | Yes | Yes | Si photonics |
| Tait et al. | N/A | N/A | Yes | Yes | Si photonics |
| 2019³⁸ | | | | | |
| Wu et al | 8 × 10⁻⁹ | N/A | Yes | Yes | SiN photonics + PCM |
| 2021³⁹ | | | | | |
| Chen et al | 0.038 | 0.0035 | Yes | No | Free space + VCSEL |
| 2023⁴⁰ | | | | | |
| Xu et al 2021⁴¹ | 11 | N/A | Yes | No | Bench-top |
| Sludds et al. | N/A | N/A (b) | Yes | No | Fiber optics |
| 2022⁴² | | | | | |
| Chen et al | 4600 | 1.3 × 10⁻⁵ | No | No | Free space optics + |
| 2023²³ | | | | | electronics |
| Ashtiani et al | 2.07 | 0.345 | No | No | Free space optics |
| 2022²⁸ | | | | | image preparation + |
| | | | | | Si Photonics |
| Zhou et al | 114 and 240 | 0.667 and 1.395 | No | No | Free space optics |
| 2021²⁶ | | | | | |
| Lin et al | N/A | N/A | No | No | Free space optics |
| 2018²⁷ | | | | | |
| Wang et al | 6.07 × 10⁻⁵ | 3.13 × 10⁵ | No | No | Free space optics |
| 2022²⁴ | | | | | |
| Wang et al | N/A | N/A | No | No | Free space optics |
| 2022²⁵ | | | | | |

(a) Also demonstrated speed of 0.38 TOPS but without the report on energy consumption.
(b) Full system energy consumption is not reported.

What is claimed is:

1. A system for performing a matrix-vector-multiplication operation in an artificial neural network, the system comprising:
a first electro-optic modulator configured to:
receive a first electronic signal encoding a data vector,
encode the first electronic signal into a first light signal, and
spatially fan-out, into different spatial modes, the first light signal into a plurality of light channels;
a plurality of second electro-optic modulators configured to:
receive a second electronic signal encoding a weight vector,
encode the second electronic signal into a plurality of second light signals, and
apply each of the plurality of second light signals to a different one of the plurality of light channels, thereby producing a plurality of combined light signals; and
a plurality of detectors configured to:
detect each of the plurality of combined light signals, and
convert each of the plurality of combined light signals into an electronic signal.

2. The system of claim 1, wherein the first electro-optic modulator comprises an electro-optic crystal.

3. The system of claim 2, wherein the electro-optic crystal comprises lithium niobate.

4. The system of claim 1, wherein the plurality of second electro-optic modulators each comprise an electro-optic crystal.

5. The system of claim 4, wherein the electro-optic crystal comprises lithium niobate.

6. The system of claim 1, wherein the first electro-optic modulator is further configured to encode the first electronic signal using amplitude modulation and the plurality of second electro-optic modulators are configured to encode the second electronic signal using amplitude modulation.

7. A method of performing a matrix-vector-multiplication operation in an artificial neural network, the method comprising:
receiving a first electronic signal encoding a data vector;
receiving a second electronic signal encoding a weight vector;
encoding the first electronic signal into a first light signal;
spatially fanning-out, into different spatial modes, the first light signal into a plurality of light channels;
encoding the second electronic signal into a plurality of second light signals;
applying each of the plurality of second light signals to a different one of the plurality of light channels, thereby producing a plurality of combined light signals;
detecting each of the plurality of combined light signals; and
converting the detected plurality of combined light signals into electronic form, thereby producing at least a portion of a result of a matrix-vector-multiplication operation.

8. The method of claim 7, wherein the encoding the first electronic signal includes modulating the first electronic signal using amplitude modulation and encoding the second electronic signal includes modulating the second electronic signal using amplitude modulation.

9. The method of claim 7, further comprising summing the plurality of combined light signals.

10. A system for performing a matrix-vector-multiplication operation in an artificial neural network, the system comprising:
an electro-optic modulator configured to:
receive a first electronic signal encoding a data vector,
encode the first electronic signal into a first light signal, and
spatially fan-out, into different spatial modes, the first light signal into a plurality of light channels;
a plurality of electro-optic amplitude attenuators configured to:
receive a second electronic signal encoding a weight vector,
encode the second electronic signal into a plurality of second light signals, and
apply each of the plurality of second light signals to a different one of the plurality of light channels, thereby producing a plurality of combined light signals;
a plurality of optical delay lines configured to:
delay each of the plurality of combined light signals using a different delay amount;
a plurality of phase shifters configured to:
phase shift each of the delayed plurality of combined light signals to produce a plurality of phase shifted light signals; and
at least one photodetector configured to:
detect the plurality of phase shifted light signals, and
convert the plurality of detected, phase shifted light signals into electronic form.

11. The system of claim 10, wherein the electro-optic modulator comprises an electro-optic crystal;

12. The system of claim 11, wherein the electro-optic crystal comprises lithium niobate.

13. The system of claim 10, wherein the plurality of electro-optic amplitude attenuators each comprise an electro-optic crystal.

14. The system of claim 14, wherein the electro-optic crystal comprises lithium niobate.

15. The system of claim 10, wherein the electro-optic modulator is further configured to encode the first electronic signal using amplitude modulation.

16. The system of claim 10, wherein the plurality of electro-optic amplitude attenuators are configured to encode the second electronic signal using amplitude modulation.

17. A method of performing a convolution operation in an artificial neural network, the method comprising:
receiving a first electronic signal encoding a data vector;
receiving a second electronic signal encoding a weight vector;
encoding the first electronic signal into a first light signal;
spatially fanning-out, into different spatial modes, the first light signal into a plurality of light channels;
encoding the second electronic signal into a plurality of second light signals;
applying each of the plurality of second light signals to a different one of the plurality of light channels, thereby producing a plurality of combined light signals;
delaying each of the plurality of combined light signals using a different delay amount;
phase shifting each of the delayed plurality of combined light signals to produce a plurality of phase shifted light signals;
detecting the plurality of phase shifted light signals; and
converting the plurality of detected, phase shifted light signals into electronic form, thereby producing at least a portion of a result of a convolution operation.

18. The method of claim 17, wherein the encoding the first electronic signal includes modulating the first electronic signal using amplitude modulation and encoding the second electronic signal includes modulating the second electronic signal using amplitude modulation.

19. A digital-to-analog converter comprising:
a plurality of electro-optic modulators coupled in series, each modulator configured to receive a digital electronic signal, wherein each of the plurality of modulators outputs a signal of a different wavelength; and
a photodetector configured to:
receive the output of the plurality of modulators, and
convert the output into electronic form.

20. The digital-to-analog converter of claim 19, wherein the plurality of modulators each comprise an electro-optic crystal, the electro-optic crystal comprising lithium niobate.
